(19) United States
(12) Patent Application Publication
(10) Pub. No.: US 2025/0392766 A1
(43) Pub. Date: Dec. 25, 2025

(54) AUGMENTED STREAMING MEDIA

(71) Applicant: International Business Machines Corporation, Armonk, NY (US)

(72) Inventors: Mauro Marzorati, Lutz, FL (US); Jeremy Ray Fox, Georgetown, TX (US); Aaron Keith Baughman, Cary, NC (US); Henrik Back-Herke, Droghed (IE)

(73) Assignee: International Business Machines Corporation, Armonk, NY (US)

(21) Appl. No.: 18/753,653

(22) Filed: Jun. 25, 2024

(51) Int. Cl. H04N 21/233; G10L 13/00; G10L 15/18

(52) U.S. Cl. CPC H04N 21/233; G10L 13/00; G10L 15/1815

(57) ABSTRACT

Methods, computer program products, and systems are presented. The method computer program products, and systems can include, for instance: examining foreground voice data of a multimedia stream that includes a video stream data and an audio stream; identifying in dependence on the examining an open time window that is absent of foreground voice data; processing, in dependence on the identifying, media stream data of multimedia stream; generating, in dependence on the processing, a text string for deployment in the open time window, wherein the text string describes content of the video stream; converting the text string into a synthesized voice segment; and adapting the audio stream data so that the synthesized voice segment is included in the audio stream and time bounded within the open time window.

Embodiments herein relate to media streaming in general and specifically to augmenting of media streams.

Streaming technology may be used to deliver multimedia content simultaneously to participants of a network-based communication. Multimedia content may include audio, video, graphics, animation, images, text, etc., as content.

Data structures have been employed for improving operation of computer systems. A data structure refers to an organization of data in a computer environment for improved computer system operation. Data structure types include containers, lists, stacks, queues, tables and graphs. Data structures have been employed for improved computer system operation e.g., in terms of algorithm efficiency, memory usage efficiency, maintainability, and reliability.

Artificial intelligence (AI) refers to intelligence exhibited by machines. Artificial intelligence (AI) research includes search and mathematical optimization, neural networks and probability. Artificial intelligence (AI) solutions involve features derived from research in a variety of different science and technology disciplines ranging from computer science, mathematics, psychology, linguistics, statistics, and neuroscience. Machine learning has been described as the field of study that gives computers the ability to learn without being explicitly programmed.

### SUMMARY

Shortcomings of the prior art are overcome, and additional advantages are provided, through the provision, in one aspect, of a method. The method can include, for example: examining foreground voice data of a multimedia stream that includes a video stream data and an audio stream; identifying in dependence on the examining an open time window that is absent of foreground voice data; processing, in dependence on the identifying, media stream data of multimedia stream; generating, in dependence on the processing, a text string for deployment in the open time window, wherein the text string describes content of the video stream; converting the text string into a synthesized voice segment; and adapting the audio stream data so that the synthesized voice segment is included in the audio stream and time bounded within the open time window.

In another aspect, a computer program product can be provided. The computer program product can include a computer readable storage medium readable by one or more processing circuit and storing instructions for execution by one or more processor for performing a method. The method can include, for example: examining foreground voice data of a multimedia stream that includes a video stream data and an audio stream; identifying in dependence on the examining an open time window that is absent of foreground voice data; processing, in dependence on the identifying, media stream data of multimedia stream; generating, in dependence on the processing, a text string for deployment in the open time window, wherein the text string describes content of the video stream; converting the text string into a synthesized voice segment; and adapting the audio stream data so that the synthesized voice segment is included in the audio stream and time bounded within the open time window.

In a further aspect, a system can be provided. The system can include, for example a memory. In addition, the system can include one or more processor in communication with the memory. Further, the system can include program instructions executable by the one or more processor via the memory to perform a method. The method can include, for example: examining foreground voice data of a multimedia stream that includes a video stream data and an audio stream; identifying in dependence on the examining an open time window that is absent of foreground voice data; processing, in dependence on the identifying, media stream data of multimedia stream; generating, in dependence on the processing, a text string for deployment in the open time window, wherein the text string describes content of the video stream; converting the text string into a synthesized voice segment; and adapting the audio stream data so that the synthesized voice segment is included in the audio stream and time bounded within the open time window.

Additional features are realized through the techniques set forth herein. Other embodiments and aspects, including but not limited to methods, computer program product and system, are described in detail herein and are considered a part of the claimed invention.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts a system having a manager system, camera devices, audio input devices, UE devices and data sources according to one embodiment;

FIG. 2A-2B is a flowchart illustrating a method for performance by a manager system interoperating with camera devices, audio input devices, and user interface (UI) devices according to one embodiment;

FIG. 3A is an original live stream timing diagram according to one embodiment;

FIG. 3B is a delayed live stream timing diagram according to one embodiment;

FIG. 4A depicts a visual language model (VLM) according to one embodiment;

FIG. 4B depicts a time window predictive model according to one embodiment;

FIG. 4D depicts a large language model (LLM) according to one embodiment;

FIG. 4E depicts a rendered text string duration predictive model according to one embodiment;

FIG. 4F depicts a WORD2VEC predictive model according to one embodiment;

FIG. 4G depicts a radio broadcast emulation predictive model according to one embodiment;

FIG. 5A depicts a first scene of a media stream according to one embodiment;

FIG. 5B depicts a second scene of a media stream according to one embodiment;

FIG. 6 depicts data flow for the generation of channel-based context pieces for prompts according to one embodiment;

FIG. 7 depicts different resolutions and sampling performed over an image that is input into a convolution neural network (CNN) for classification according to one embodiment;

FIG. 8 depicts process flow for different levels of sound windows according to one embodiment;

FIG. 9 depicts an artificial neural network (ANN) according to one embodiment;

FIG. 10 depicts a computing environment according to one embodiment.

### DETAILED DESCRIPTION

In one aspect, embodiments herein can optionally include examining foreground voice data of a multimedia stream that includes a video stream data and an audio stream; identifying in dependence on the examining an open time window that is absent of foreground voice data; processing, in dependence on the identifying, media stream data of multimedia stream; generating, in dependence on the processing, a text string for deployment in the open time window, wherein the text string describes content of the video stream; converting the text string into a synthesized voice segment; and adapting the audio stream data so that the synthesized voice segment is included in the audio stream and time bounded within the open time window. According to an example of a technical effect of the combination, information presented visually can be received audibly by a user.

According to one optional feature, the adapting includes modifying a delayed instance of the multimedia stream. According to an example of a technical effect of the combination, audio data can be accurately placed to avoid overlap with foreground voice data.

According to one optional feature, the processing media stream data of the multimedia stream includes processing video data timestamped within the open time window. According to an example of a technical effect of the combination, information presented visually can be received audibly by a user.

According to one optional feature, the processing media stream data of the multimedia stream includes processing foreground voice data timestamped about the open time window. According to an example of a technical effect of the combination, the synthesized voice segment can be configured based on the foreground voice data.

According to one optional feature, the processing media stream data of the multimedia stream includes processing media stream data to predict a time duration of the open time window, and wherein the generating is performed in dependence on the predicted time duration. According to an example of a technical effect of the combination, audio data can be accurately placed to avoid overlap with foreground voice data.

According to one optional feature, the processing media stream data of the multimedia stream includes processing media stream data to predict a style of the open time window, and wherein the generating is performed in dependence on the predicted style. According to an example of a technical effect of the combination, the synthesized voice segment can be configured based on the predicted style for improved user interface engagement of a user.

According to one optional feature, the processing media stream data of the multimedia stream includes processing media stream data to predict a semantic meaning of foreground voice segment data associated to the open time window, and wherein the generating is performed in dependence on the predicted semantic meaning. According to an example of a technical effect of the combination, user interface engagement of a user can be improved.

According to one optional feature, the generating, in dependence on the processing, the text string for deployment in the open time window includes performing evaluating of text string data of the text string according to time window fitment factor, wherein the performing evaluating includes determining a degree to which a predicted time for voice synthesized rendering of the text string data matches a predicted duration of the open time window. According to an example of a technical effect of the combination, audio data can be accurately placed to avoid overlap with foreground voice data.

According to one optional feature, the generating, in dependence on the processing, the text string for deployment in the open time window includes performing evaluating of text string data of the text string according to a style matching factor, wherein the performing evaluating includes determining a degree to which an extracted sentiment of the text string data extracted by subjecting the text string data to natural language processing matches an extracted sentiment of the open time window, wherein extracting sentiment of the open time window includes processing video data of the open time window. According to an example of a technical effect of the combination, user interface engagement of a user can be improved.

According to one optional feature, the generating, in dependence on the processing, the text string for deployment in the open time window includes evaluating text string data of the text string according to a semantic meaning redundancy factor, and qualify the text string data for deployment responsively to a determination that a sematic meaning of the text string data is not redundant to a semantic meaning of foreground voice data associated to the open time window. According to an example of a technical effect of the combination, user interface engagement of a user can be improved.

According to one optional feature, the generating, in dependence on the processing, the text string for deployment in the open time window includes performing evaluating of text string data of the text string according to an audio-only broadcast emulation factor, wherein the performing evaluating includes determining a degree to which a semantic meaning of the text string data emulates an audio-only broadcast. According to an example of a technical effect of the combination, information presented visually can be received audibly by a user.

According to one optional feature, the method includes identifying an announcer associated to the foreground voice data, pulling supplemental domain data of the announcer responsively to the identifying, prompting a neural network machine learning model using the supplemental domain data, predicting a duration of the open time window based on an output of the predictive model from the prompting, selecting the text string in dependence on the predicted duration, recording data specifying an actual duration of the open time window, further training the neural network machine learning model using the recorded data specifying the actual duration of the open time window, discovering a subsequent open time window during streaming of the multimedia stream, re-prompting the neural network machine learning model responsively to the discovering, and predicting a duration of the subsequent open time window in dependence on the further training. According to an example of a technical effect of the combination, accuracy of the system improves over time.

According to one optional feature, the processing media stream data of the multimedia stream includes recognizing based on processing video data of open time window, a certain attribute indicative of an alert game event of a sports game, prompting a sentiment predicting machine learning model with use of the certain attribute, wherein the sentiment predicting machine learning model has been trained with labeled training data associating certain sentiment to the certain attribute, outputting a predicted sentiment based on the prompting, and configuring acoustical characteristics of the synthesized voice segment in dependence on the predicted sentiment. According to an example of a technical effect of the combination, user interface engagement of a user can be improved.

According to one optional feature, method includes selecting text string data for deployment, identifying a break point of the text string data that divides the text string data into the text string and a second text string, storing the second text string to a data repository, and deploying the second text string to a next open time window. According to an example of a technical effect of the combination, audio data can be accurately placed to avoid overlap with foreground voice data.

According to one optional feature, the processing media stream data of the multimedia stream includes processing media stream data to predict (i) a time duration of the open time window, (ii) a sentiment of the open time window, and (iii) a semantic meaning of foreground voice segment data associated to the open time window, wherein the generating, in dependence on the processing, the text string for deployment in the open time window includes selecting the text string to (a) match the time duration of the open time window, (b) match the sentiment of the open time window, and (c) avoid redundancy with the semantic meaning of foreground voice segment data associated to the open time window. According to an example of a technical effect of the combination, user interface engagement of a user can be improved.

According to one optional feature, the processing media stream data of the multimedia stream includes processing media stream data to predict (i) a time duration of the open time window, (ii) a sentiment of the open time window, and (iii) a semantic meaning of foreground voice segment data associated to the open time window, wherein the generating, in dependence on the processing, the text string for deployment in the open time window includes selecting the text string to (a) match the time duration of the open time window, (b) match the sentiment of the open time window, and (c) avoid redundancy with the semantic meaning of foreground voice segment data associated to the open time window, wherein the generating, in dependence on the processing, the text string for deployment in the open time window includes (1) obtaining one or more video data frame timestamped about a time of the open time window, and (2) applying the one or more video data frame timestamped about a time of the open time window as model prompting data to a visual language model (VLM) that has been trained with iterations of training data, wherein the iterations of training data include historical frame data labeled with descriptive text, (3) obtaining output text output from the VLM responsively to the applying, (4) prompting a large language model (LLM) using the output text output from the VLM, (5) evaluating VLM-output text strings output by the LLM responsively to the prompting as candidate text strings for deployment in the open time window, wherein the VLM-output text strings include the text string, and (6) selecting the text string from the candidate text strings based on the evaluating, wherein the evaluating includes a time window fitment evaluation factor, a style matching factor, and a factor that includes evaluation of a semantic meaning of the candidate text strings. According to an example of a technical effect of the combination, interactive presentment of prompting data according to the combination can enhance user interface engagement of one or more worker with a workflow environment to facilitate improved operating performance of one or more physical asset within the workflow environment. According to an example of a technical effect of the combination, user interface engagement of a user can be improved.

According to one optional feature, the generating, in dependence on the processing, the text string for deployment in the open time window includes (a) obtaining one or more video data frame timestamped about a time of the open time window, and (b) applying the one or more video data frame timestamped about a time of the open time window as model prompting data to a machine learning model that has been trained with iterations of training data, wherein the iterations of training data include historical frame data labeled with descriptive text. According to an example of a technical effect of the combination, information presented visually can be received audibly by a user.

According to one optional feature, the generating, in dependence on the processing, the text string for deployment in the open time window includes (a) obtaining one or more video data frame timestamped about a time of the open time window, and (b) applying the one or more video data frame timestamped about a time of the open time window as model prompting data to a visual language model (VLM) that has been trained with iterations of training data, wherein the iterations of training data include historical frame data labeled with descriptive text, (c) obtaining output text output from the VLM responsively to the applying, (d) prompting a large language model (LLM) using the output text output from the VLM, (e) evaluating VLM-output text strings output by the LLM responsively to the prompting as candidate text strings for deployment in the open time window, wherein the VLM-output text strings include the text string, and (f) selecting the text string from the candidate text strings based on the evaluating, wherein the evaluating include time window fitment evaluation factor, a style matching factor, and a factor that includes evaluation of a semantic meaning of the candidate text strings. According to an example of a technical effect of the combination, user interface engagement of a user can be improved.

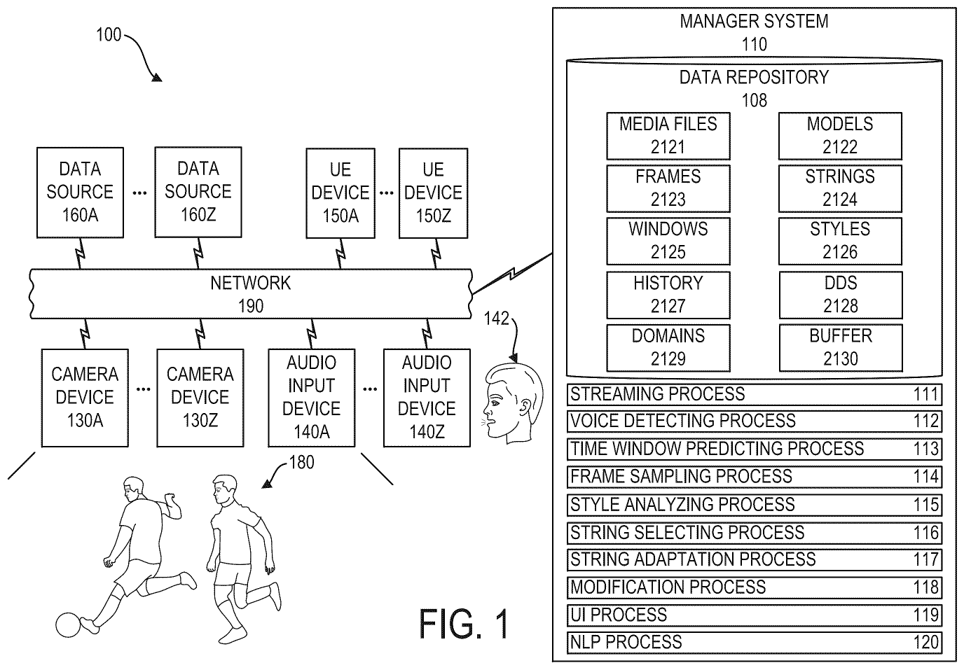

System 100 for use in augmenting streaming media is shown in FIG. 1. System 100 can include manager system 110 having an associated data repository 108, camera devices 130A-130Z, audio input devices 140A-140Z, user equipment (UE) devices 150A-150Z, and data sources 160A-160Z. Manager system 110 camera devices 130A-130Z, audio input devices 140A-140Z, UE devices 150A-150Z, and data sources 160A-160Z can be computing node based devices in communication with one another via network 190. Network 190 can be a physical network and/or a virtual network. A physical network can be, for example, a physical telecommunications network connecting numerous computing nodes or systems, such as computer servers and computer clients. A virtual network can, for example, combine numerous physical networks or parts thereof into a logical virtual network. In another example, numerous virtual networks can be defined over a single physical network.

In one embodiment, system 100 can be used for generating an augmented media stream representing a live event 180 such as a live supporting event, or other typer of entertainment event. Embodiments herein recognize that media streams representing e.g. live events and other media streams, e.g., movie media streams, television show media streams, newscasts media streams, lectures media streams, and the like can be characterized by foreground voice data. Foreground voice data can be voice data provided, e.g., by announcer 142 in the case of a live event such as live event 180, voice data of a newscaster, voice data of an actor in a movie or television show, and the like.

Embodiments herein can provide supplementary voice data that supplements primary voice data of a media stream. Embodiments herein can automatically augment the media stream to include supplementary voice data. In one embodiment, supplementary voice data can include audio description voice data that provides a description of video data included within a media stream and specifies features that are viewable by viewing rendered video data of the stream.

Supplementary voice data can benefit all users engaging with a media stream and in particular to users who are unable to see video data of the media stream on rendering and presenting thereof. Users who are unable to see presented video data of a media stream can include, e.g., sight-impaired users, multitasking users, e.g. drivers in the case that a media file is being played in the background within a moving vehicle, radio listeners who are listening to a radio feed of a media stream that is absent of video rendering and the like.

Embodiments herein define improvements in the technology of artificial vision in that embodiments provide audible descriptions of attributes within presented video that is readily observable by a person viewing the video but is not available to a user who does not have access to the video.

Embodiments herein recognize that speakers of a media stream tend not to describe attributes that are readily observable within scenes associated to the media stream, i.e., a game announcer is not likely to say something like the referee has tossed the ball into the air to commence tip off when the viewing user can easily see that the referee commenced the tip off. Accordingly, embodiments herein provide the eyes for users without access to presented video.

Data repository 108 can store various data. Data repository 108 in media files area 2121 can store media files. Media files stored in media files area 2121 can include, e.g., multimedia files that include combined video data and audio data. Media files stored in media files area 2121 can include e.g. recorded media files of movies, television shows, lectures, newscasts, and the like. In one aspect, system 100 can be commanded to obtain a media file from media files area 2121 and subject such obtain the media file to processing for augmentation of the media file to include supplementary video data as set forth herein. In another use case, system 100 can be used to stream a live entertainment event.

Data repository 108 in models area 2122 can store predictive models. Predictive models stored in models area 2122 can include, e.g., one or more visual language model (VLM) that has been trained via fine tuning training, and/or one or more trained large language model (LLM) that has been trained via fine-tuned training. Models of models area 2122 can include additional predictive models, e.g., predictive models trained to predict time delays, styles, semantic meanings, and the like.

Data repository 108 in frames area 2123 can include, e.g., still and/or or moving video frames obtained from a media stream. Video frames obtained from a media stream can be subject to processing, e.g., for pattern detection, event detection, time delay predictions, and/or style derivation. In one use case video frame(s) of frames area 2123 can be applied as model prompting data to one or more predictive model. In one embodiment, frames area 2123 can be defined by cache memory and/or working memory of manager system 110.

Data repository 108 in strings area 2124 can store strings generated during a current open time window characterizing period. When characterizing an open time window, manager system 110 can generate text strings including multi-word and single word text strings. The text strings, e.g., can be evaluated for deployment as rendered supplementary voice data, and/or used as model prompting data to drive additional outputs.

Data repository 108 in time windows area 2125 can store predicted or otherwise determined time open time windows of a current media stream. Open time windows herein can include windows of time within a media stream that are absent of foreground voice data. Such open time windows can include, e.g., pauses by a live event announcer, periods of silence by actors in a movie or show, and the like.

Data repository 108 in styles area 2126 can store data specifying a style of a current open time window of a current media stream being characterized. A style of an open time window can include, e.g., one or more sentiment parameter value, one or more culture parameter values, and/or one or more speech pattern parameter value.

Data repository 108 in history area 2127 can store historical data of historical open time windows characterized by manager system 110 including from the current media stream session and prior historical media stream sessions. History data in history area 2127 recorded for an open time window can include e.g. data specifying an observed open time window duration, detected actions, detected patterns, foreground voice segments associated to the window (e.g., just before, just after) and the like.

Manager system 110 can iteratively use data recorded in history area 2127 for training one or more machine learning predictive model. In one embodiment, the described one or more predictive model can be queried multiple times during a single media stream and trained with history data of history area 2127 of the same media stream multiple times during the same media stream. In such an embodiment, system 100 learns over time and becomes more accurate based on in-stream collected history data.

Manager system 110 in decision data structures area (DDS) 2128 can store decision data structures for use in return of action decisions by manager system 110. Decision data structures of decision data structures area 2128 can include, e.g., decision tables and decision trees.

Data repository 108 in domains area 2129 can include data on domain entities represented within media streams that are processed by manager system 110, e.g., persons, teams, places, buildings, and the like. Independent of any streaming, system 100 can collect data on entity domains expected to be represented in streams. Data sources 160A-160Z can be configured to iteratively send entity domain data for storage into domains area 2129. In addition to including collected entity data collected streaming sessions, domain entity data can include historical data metadata independent of any collected entity data collected in a streaming session, e.g., can include biographies of persons, performance records of athletes, team records, history of places, history of buildings, years of experience of an announcer, number of games called by an announcer, etc. When manager system 110 during session recognizes an entity, e.g., via pattern recognition, manager system 110 can pull the described metadata for assembly into a text string delivered to a user, and/or can use the metadata for performance of model prompting. Based on consent and acknowledgment by persons represented within media streams, manager system 110 can record identifying data respecting various persons that are represented within scenes, e.g., announcers, actors, presented athletes, and the like. Manager system 110 can use data of domains area 2129, e.g., for recognizing specific persons within represented scenes, e.g., via voice data, and/or video data. Manager system 110 can apply data of domains area 2129 for training predictive models and can query such predictive models that have been trained based on domain data of domains area 2129 for return of more accurate predictions. In one aspect, domains area 2129 can include speech profiles of persons expected to be recognized in media sessions. The speech profiles can include, e.g., voice prints to permit identification as well as baseline characteristics of a certain person's speech, from which relative parameters can be returned, e.g., what is regarded to be “faster” speech can be determined in reference to a baseline speech rate for a particular person and therefore can be determined differently depending on which person is speaking. Such profile data can facilitate sentiment detection via processing voice data. Manager system 110 can apply data of domains area 2129 for performance of edits to candidate text strings, e.g., for changing a generic entity name to a specific entity name.

Manager system 110 can run various processes. Manager system 110 running streaming process 111 can include manager system 110 configuring video data and/or audio data for delivery and presentation to one or more user at a remote playback device, e.g. which can be provided by a UE device of UE devices 150A-150Z.

Manager system 110 running streaming process 111 can include manager system configuring media data for delivery with use in accordance with the real-time transport protocol (RTP) which is described in RFC 3550. RFC 3550, which is entitled “RTP: A Transport Protocol for Real-Time Applications,” sets forth the Real-time Transport Protocol (RTP). RTP can be employed for streaming media, video conferencing, telephony, and other applications requiring timely delivery of media. RTP is designed for end-to-end, real-time data transmission over multicast or unicast network services. RTP includes mechanisms for timestamping, payload type identification, sequence numbering as well as delivery monitoring. RTP can interoperate with RTP Control Protocol (RTCP) to provide quality feedback and synchronization between media streams. RTP can be adapted to different network environments and can be scaled support both small and large groups.

Manager system 110 running voice detecting process 112 can include manager system 110 detecting one or more human voice within a media stream. Manager system 110 running voice detecting process 112 can include manager system 110 performing voice detection according to one or more voice detection techniques. Voice detection within streaming media can be achieved through various methods such as Voice Activity Detection (VAD). VAD can distinguish speech from non-speech segments with use of energy levels and spectral properties. In one aspect, spectral analysis, using methods like Short-Time Fourier Transform (STFT) can be employed to identify voice frequencies. In a further aspect, acoustic feature extraction methodologies, e.g., Mel-Frequency Cepstral Coefficients (MFCCs), help identify characteristics unique to human voice. Manager system 110 performing voice detecting process 112 can include manager system 110 detecting a particular person's voice. Detecting a particular person's voice via audio, known as speaker recognition, can include e.g., high-quality audio samples, feature extraction, e.g., using Mel-Frequency Cepstral Coefficients (MFCCs), and model training using techniques like Gaussian Mixture Models (GMMs) or advanced deep learning methods such as Convolutional Neural Networks (CNNs) and Recurrent Neural Networks (RNNs). Manager system 110 can identify a speaker by comparing extracted features from new audio samples against trained models of models area 2122 trained with used of voice prints from domains area 2129.

Manager system 110 running time window predicting process 113 can include manager system 110 predicting the duration of an open time window responsively to the detection of a foreground voice data segment terminating within a media stream. Embodiments herein recognize that in case of a live event, different action events and/or patterns can include different associated open time windows that can be accurately predicted with use of machine learning. For example, a golf announcer (for purposes of emulating a live bystander) may not speak during the time when a golfer being represented in a media stream stands over a golf ball and the time that the golfer completes golf swing. A sporting event announcer, according to another example, may also remain silent when crowd reaction is being shown after a score. In another example, a baseball announcer may refrain from narrating a baseball game during the time that a baseball player moves from a batter box to a batter position at home plate. In another example, an announcer may refrain from speaking when a scene of a coach or manager is being shown. In another example, an announcer may refrain from speaking when a routine play is being made by a team, that is clearly discernible by viewing video data. Manager system 110 performing time window predicting process 113 can include manager system 110 processing, e.g., video data, audio data, and/or text data.

Manager system 110 running frame sampling process 114 can include manager system 110 selecting one or more video frame from a media stream. Frames selected by manager system 110 performing frame sampling process 114 can be presented as model prompting data to a predictive model that has been trained via machine learning training to return text strings describing certain video data when subjected to prompting using the certain video data. Manager system 110 can employ a command line tool, e.g., FFmpeg, for selecting and storing individual frames, and/or successions of frames from a media stream.

Manager system 110 running style analyzing process can include manager system 110 deriving a style of a current scene. Embodiments herein recognize that for improved engagement of a user to a media stream, supplementary voice data can be configured to match a style of a current open time window being subject to characterization. Manager system 110 running style analyzing process 115 can include manager system 110 processing, e.g., video data, audio data, and/or text data for return of one or more sentiment parameter value, one or more culture parameter value, and/or one or more speech characteristic parameter value.

Manager system 110 running string selecting process 116 can include manager system 110 generating one or more candidate text string and selecting from the one or more candidate text string the text string for deployment for defining an augmented media stream. Manager system 110 running string selecting process 116 can include manager system 110 evaluating a plurality of generated candidate text strings according to multi factor evaluation process. The multi factor evaluation process can include applying an equation that scores respective candidate text strings according to a multi factor formula. The factors of the multiple factor formulas can include, e.g., a time window matching factor, a style matching factor, a redundancy avoidance factor, a radio emulation factor, and the like.

Manager system 110 performing string adaptation process 117 can include manager system 110 trimming and truncating a text string for deployment into a media stream. Manager system 110 performing string adaptation process 117, in one embodiment, can be performed conditionally on the condition that a selected text string when rendered in synthesized in voice will be potentially too long and therefore overlap foreground voice data of a media stream being modified.

Manager system 110 running modifying process 118 can include manager system 110 modifying a media stream to include synthesized voice data. Manager system 110 running modifying process 118 can include manager system 110 selecting attributes of synthesized voice to match a determined style of a current open time window currently being characterized by manager system 110. For performing modifying process 118 manager system 110 in one embodiment can employ features of the libavfilter library of the FFmpeg suite. The libavfilter library provides a comprehensive collection of filters for audio and video processing, and enables users to create filter graphs, which are networks of interconnected filters, to perform complex transformations and effects on media files. In one embodiment, the amix filter in FFmpeg can be used to mix multiple audio inputs into a single output. Manager system 110 running modifying process 118 can include, in one embodiment, manager system 110 removing video data from a multimedia (video and audio) to produce a radio (audio only) stream option for users. Users can elect to receive the radio stream where the user will be multitasking, for example. Providing a radio stream option economizes computing resource utilization.

Manager system 110 running user interface (UI) process 119 can include manager system 110 providing user interface selection functionality to administrator users of system 100 and also end users of system 100. UE devices of UE devices 150A-150Z can include administrator user UE devices and end-user UE devices. End user UE devices can include appropriate playback software to facilitate playback of media streams that are streams thereto by manager system 110.

Manager system 110 can run a natural language processing (NLP) process 120 for determining one or more NLP output parameter of a message. NLP process 120 can include one or more of a topic classification process that determines topics of messages and output one or more topic NLP output parameter, a sentiment analysis process which determines sentiment parameter for a message, e.g., polar sentiment NLP output parameters, “negative,” “positive,” and/or non-polar NLP output sentiment parameters, e.g., “anger,” “disgust,” “fear,” “joy,” and/or “sadness” or other classification process for output of one or more other NLP output parameters e.g., one of more “social tendency” NLP output parameter or one or more “writing style” NLP output parameter.

By running of NLP process 120 manager system 110 can perform a number of processes including one or more of (a) topic classification and output of one or more topic NLP output parameter for a received message (b) sentiment classification and output of one or more sentiment NLP output parameter for a received message or (c) other NLP classifications and output of one or more other NLP output parameter for the received message.

Topic analysis for topic classification and output of NLP output parameters can include topic segmentation to identify several topics within a message. Topic analysis can apply a variety of technologies e.g., one or more of Hidden Markov model (HMM), artificial chains, passage similarities using word co-occurrence, topic modeling, or clustering. Sentiment analysis for sentiment classification and output of one or more sentiment NLP parameter can determine the attitude of a speaker or a writer with respect to some topic or the overall contextual polarity of a document. The attitude may be the author's judgment or evaluation, affective state (the emotional state of the author when writing), or the intended emotional communication (emotional effect the author wishes to have on the reader). In one embodiment sentiment analysis can classify the polarity of a given text as to whether an expressed opinion is positive, negative, or neutral. Advanced sentiment classification can classify beyond a polarity of a given text. Advanced sentiment classification can classify emotional states as sentiment classifications. Sentiment classifications can include the tonal classification of “anger,” “disgust,” “fear,” “joy,” and “sadness.” Manager system 110 running NLP process 120 can include manager system 110 returning NLP output parameters in addition to those specification topic and sentiment, e.g., can provide sentence segmentation tags, and part of speech tags. Manager system 110 can use sentence segmentation parameters to determine e.g., that an action topic and an entity topic are referenced in a common sentence for example.

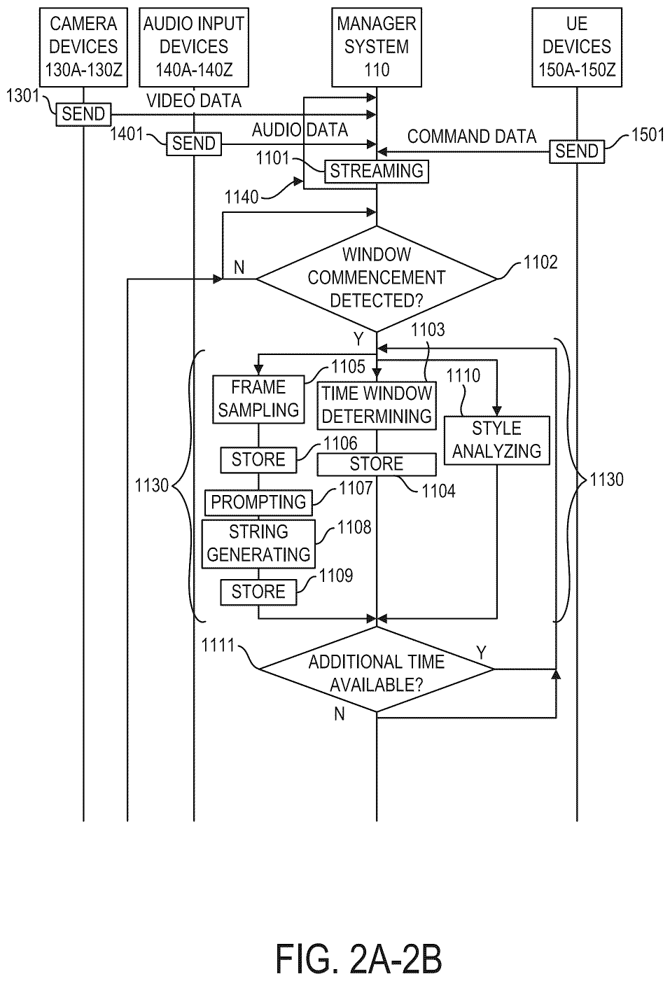

A method for performance by manager system 110 interoperating with camera devices 130A-130Z, audio input devices 140A-140Z, and UE devices 150A-150Z is set forth in reference to the flowchart of FIG. 2A-2B.

At block 1301, camera devices 130A-130Z can be sending video data for receipt by manager system 110 which can be buffering the received video data on receipt thereof. At block 1401, audio input devices 140A-140Z can be sending audio data for receipt by manager system which can be buffering audio data on receipt thereof. In reference to FIG. 1, the sent video data and audio data sent at blocks 1301 and 1401 can be video data and audio data of a live event 180 such as a live sporting event or another type of live event. Camera devices 130A-130Z can be deployed, e.g., to capture representations of game players, coaches, spectators, announcers, and the like. Audio input devices 140A-140Z can be deployed to capture audio data e.g. of players, spectators, announcers and the like.

At block 1501 users of UE devices 150A-150Z can send command data for receipt by manager system 110. Users of UE devices 150A-150Z can include e.g., administrator users and end-users, which end-users can be associated thereto UE devices configured as playback UE devices.

Command data defined by administrators and users can include e.g. command data to establish configuration settings, e.g. for sizes of time delays, factors to be considered in multi factor evaluations, active models to be deployed in a media stream augmentation process, and the like. Command data defined by end users can include, e.g., command data to present in playback media stream supplementary voice data as set forth herein which supplements foreground voice stream voice data. Command data from an end user in one embodiment can include command data to receive a radio stream from which video data has been removed. The processing of multimedia (video and audio) stream to provide a radio (audio only) stream option for users economized computing resources utilization of system 100 and reduces bandwidth.

At streaming block 1101, in response to receipt of the sent video data, audio data, and command data manager, manager system 110 can configure received video data and audio data for streaming. Manager system 110 performing streaming block 1101 can include manager system 110 configuring received video data and audio data for delivery to remote users in accordance with the real-time transport protocol (RTP) which is described in request for comments RFC 3550. RFC 3550, which is entitled “RTP: A Transport Protocol for Real-Time Applications,” sets forth the Real-time Transport Protocol (RTP). RTP can be employed for streaming media, video conferencing, telephony, and other applications requiring timely delivery of media. RTP is designed for end-to-end, real-time data transmission over multicast or unicast network services. RTP includes mechanisms for timestamping, payload type identification, sequence numbering as well as delivery monitoring. RTP can interoperate with RTP Control Protocol (RTCP) to provide quality feedback and synchronization between media streams. RTP can be adapted to different network environments and can be scaled support both small and large groups.

At streaming block 1101 can initiate processing of the produced media stream and can produce a delayed instance of the produced media stream. In one use case of streaming block 1101, manager system 110 can configure video and audio data of a live event into a live stream. In another use case of streaming block 1101, manager system 110 based on command data sent at block 1501 can initiate streaming of selected recorded media from media files area 2121. The streaming can be performed on a live bases (as in a scheduled television broadcast) on an on-demand basis. As indicated by return loop 1140 streaming performed by manager system 110 is understood as being performed on an ongoing basis until terminated.

In response to streaming block 1101, manager system 110 can proceed to block 1102. At block 1102, manager system 110 can detect for the commencement of an open time window. An open time window herein refers to an open period of an audio stream characterized by an absence of foreground voice data, e.g., periods where a speaker producing foreground voice data is not speaking. At block 1102, manager system 110 can subject the resulting media stream produced at streaming block 1101 to processing for detection of foreground voice data in the in the video in the media stream. Manager system 110 can employ various methods for voice detection. Voice detection within streaming media can be achieved through various methods such as Voice Activity Detection (VAD). VAD can distinguish speech from non-speech segments with use of energy levels and spectral properties. In one aspect, spectral analysis, using methods like Short-Time Fourier Transform (STFT) can be employed to identify voice frequencies. In a further aspect, acoustic feature extraction methodologies, e.g., Mel-Frequency Cepstral Coefficients (MFCCs), help identify characteristics unique to human voice. Manager system 110 performing voice detecting at block 1102 can include manager system 110 detecting a particular person's voice. Detecting a particular person's voice via audio, known as speaker recognition can include e.g., high-quality audio samples, feature extraction, e.g., using Mel-Frequency Cepstral Coefficients (MFCCs), and model training using techniques like Gaussian Mixture Models (GMMs) or advanced deep learning methods such as Convolutional Neural Networks (CNNs) and Recurrent Neural Networks (RNNs). Manager system 110 can identify a speaker by comparing extracted features from new audio samples against trained models of models area 2122 trained with used of voice prints from domains area 2129.

Manager system 110 can iteratively perform open time window commencement detection at block 1102 until a time that commencement of an open voice time window has been detected.

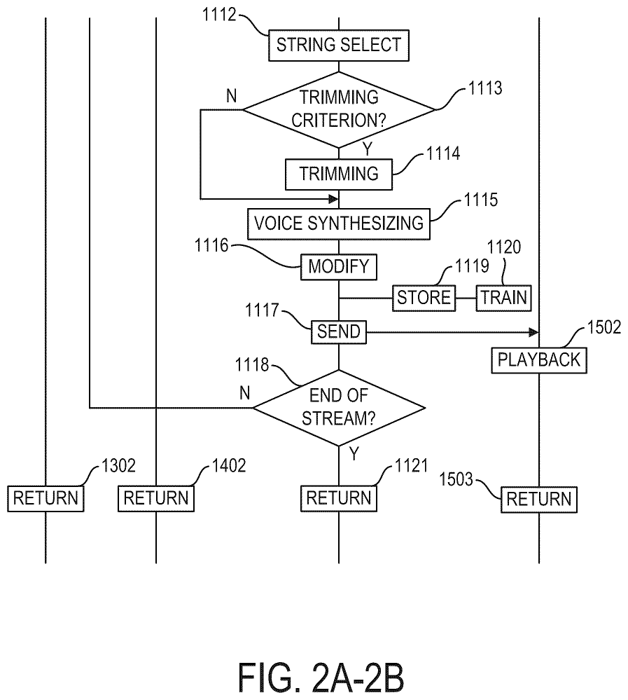

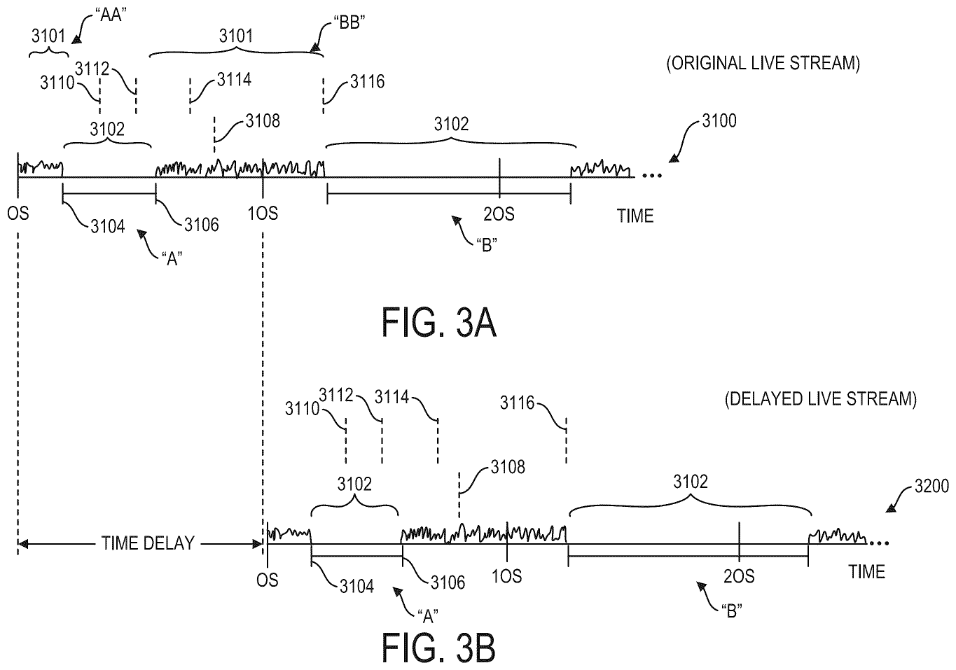

Referring to FIG. 3A, FIG. 3A depicts an original live stream 3100 which is subject to processing by manager system 110 at block 1102. FIG. 3B depicts a delayed live stream 3200 produced by manager system 110 at streaming block 1101. The delayed live stream 3200 of FIG. 3B can be an exact replica of the original live stream of FIG. 3A, except that the delayed live stream 3200 can include injected supplemental voice data within identified open time windows, such as open time windows 3102 that are replicated from original live stream 3100 in delayed live stream 3200.

Time 3104 depicted in FIG. 3A, refers to a detected open voice window commencement time, i.e., a time at which foreground voice data is not detected.

On detection of an open time window commencement, i.e., at time 3104, manager system 110 as depicted in the flow chart of FIG. 2A-2B can commence a number of processes contemporaneously, e.g., time window determining at block 1103, frame sampling at block 1105, style analyzing at block 1110.

At time window determining block 1103, manager system 110 can determine an open time window period of a current open time window being characterized. At frame sampling block 1105, manager system 110 can select one or more frame of a current video stream for processing. At style analyzing block 1110, manager system 110 can perform one or more process for determining a style associated to a current open voice window.

In one embodiment, manager system 110 at time window determining at block 1103 and style analyzing at block 1110 can make use of sampled frames sampled at frame sampling block 1105.

Referring to frame sampling block 1105, manager system 110 at frame sampling block 1105 can sample one or more frame. Manager system 110 can perform frame sampling employing various processes. Manager system 110 can employ a command line tool, e.g., FFmpeg, for selecting and storing individual frames, and/or sets, e.g., successions of frames from a media stream. The one or more frame sampled at a first iteration of block 1105 can be timed to the detected open time period, according to one embodiment. In one embodiment, one or more frame sampled at block 1105 can have timestamp(s) at or about the timestamp of the commencement (time 3104) of the detected open time window.

On completion of frame sampling block 1105, manager system 110 can store at store block 1106 the sampled one or more frame parsed from a current video stream into frames area 2123 of data repository 108. When selected and stored at blocks 1105 and 1106, frames can be employed for various uses by manager system 110. In one aspect, frames sampled at block 1105 can be employed as model prompting data for prompting predictive models for return of descriptive text strings. Manager system 110 can further, e.g., employ sampled frames for use in time window predicting and style analyzing.

In reference to time window determining at block 1103, manager system 110 can predict the duration of the time window based on one or more action detected with use of processing one or more frame of a sampled frame sampled as sample block 1105. Referring to style analyzing at block 1110, style analyzing by manager system 110 can include manager system 110 performing a sentiment analysis of one or more sampled frame.

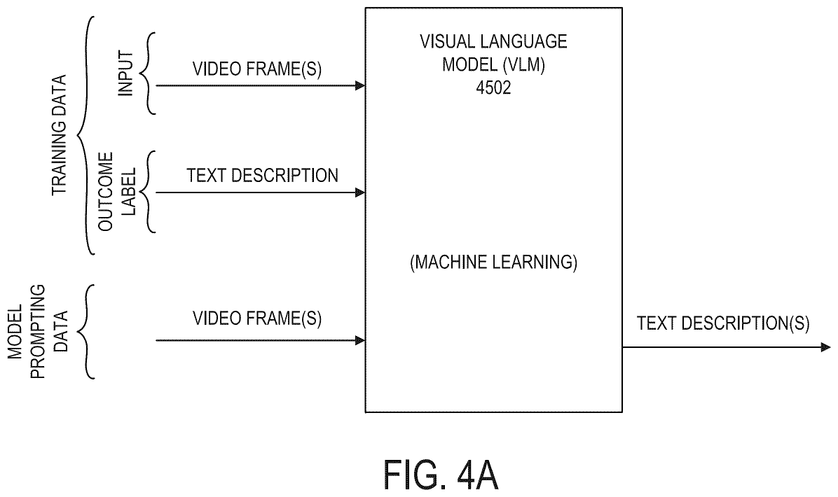

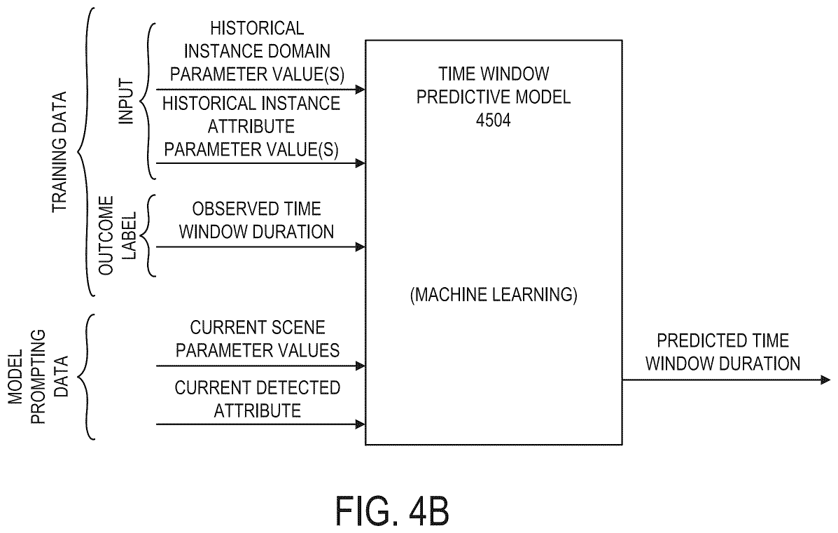

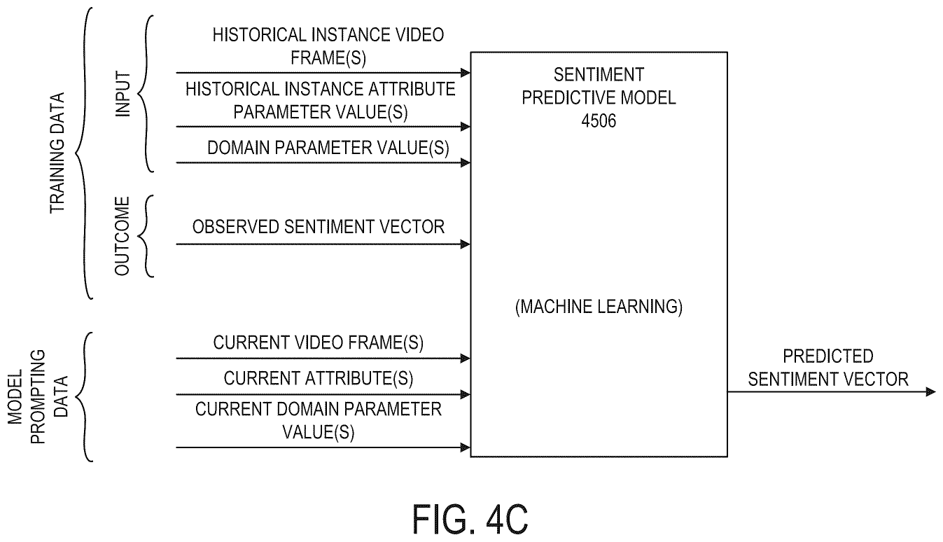

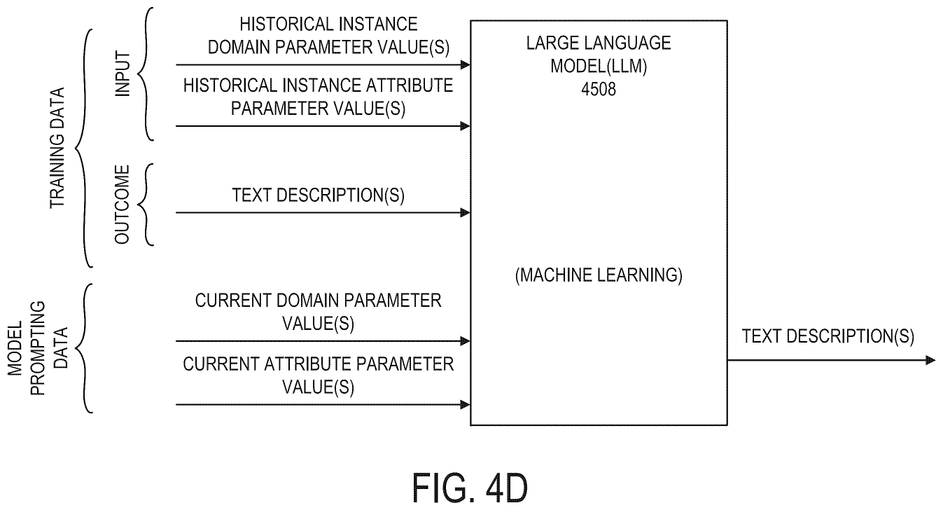

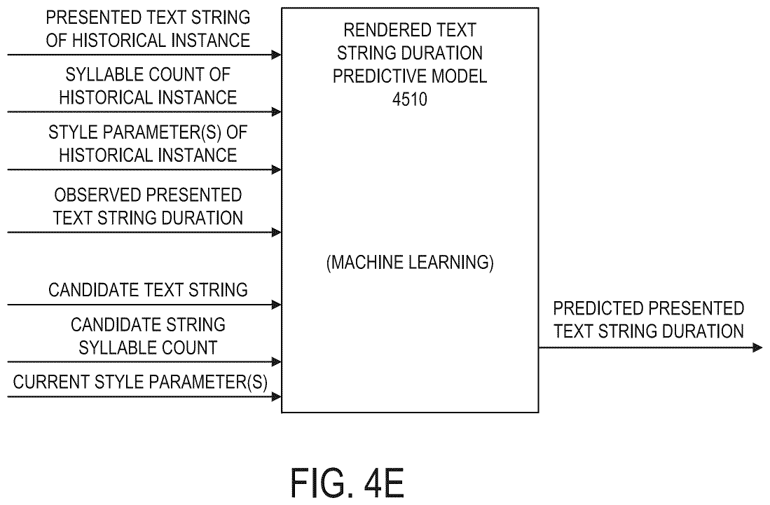

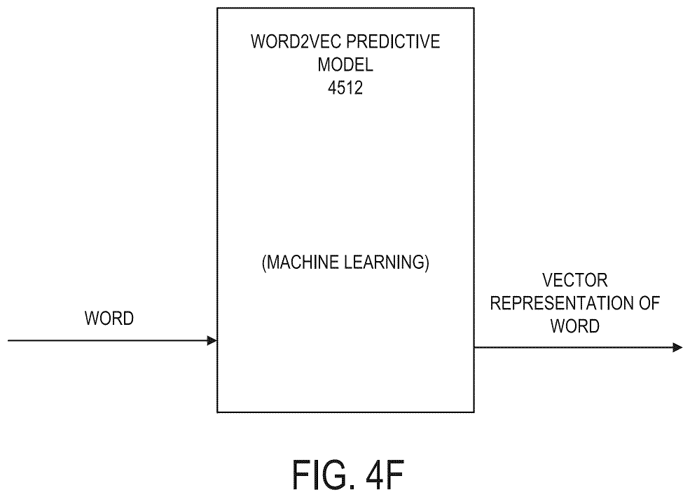

On completion of store block 1106, manager system 110 can proceed to model prompting block 1107. At model prompting block 1107, manager system 110 can query visual language model (VLM) 4502 as shown in FIG. 4A. A visual language model (VLM) herein refers to an artificial intelligence system designed to understand and generate multimodal content that combines both visual and textual information. VLM 4502 can combine computer vision, which interprets images and videos, with natural language processing, which handles text. VLM 4502 can be trained on large datasets containing paired visual and textual data, enabling VLM 4502 to perform tasks like image captioning, where they generate descriptive text for images, and visual question answering, where they answer questions about image content. VLM 4502 can incorporate architectures such as convolutional neural networks (CNNs) for visual data and transformers for textual data, VLM 4502 can be trained to learn relationships between visual elements and language, making VLM 4502 capable of tasks that require an understanding of both modalities.

Referring to VLM 4502 of FIG. 4A, VLM 4502 can be provided by a foundational visual language model which has been subject to fine tuning training to define VLM 4502. Pre-training VLM 4502 using self-supervised learning can include applying as training data large-scale datasets of paired visual and textual data that can be absent of explicit labels. Pre-training can include creating pretext tasks such as image-text matching, where the model learns to predict whether a given image and text pair correspond, and contrastive learning, which aligns image and text embeddings in a shared space by bringing matching pairs closer and pushing non-matching pairs apart. In one aspect, masked language modeling (MLM) for text and masked image modeling (MIM) for visual data can be employed to improve contextual understanding. Various architectures can be employed, e.g., CNNs and/or transformers, which can be trained jointly on these tasks.

Fine tuning training of VLM 4502 can include subjecting VLM 4502 to supervised learning with use of iterations of fine-tuning training data, wherein iterations of fine-tuning training data can include one or more video frame applied as input training data associated to a text description defining a text string associated to one or more video frame applied as outcome training data. The text strings applied as training data can be administrator user defined, and/or can be collected from historical video/audio samples. The text strings applied as training data can be multi-word (e.g., as in a descriptive narration), or single word, e.g., as in a classifier. The fine-tuning learning descriptive text strings can describe patterns (discernible from a single frame) and/or actions (discernible from a single frame and in some instances a sequence of frames). Descriptions input as training data can include multi-word, e.g., sentence descriptions (“player a kicks ball to player b”) which can be regarded as narration descriptions and/or single word descriptions (ball, player, kick) which can be regarded as classifier descriptions.

VLM 4502, once trained by fine tuning training, can be responsive to prompting data. Prompting data for prompting VLM 4502 to produce one or more text description of one or more video frame can include the one or more video frame sampled at block 1105. On being subject to prompting, VLM 4502 can output various text descriptions in dependence on its training, e.g., a collection of narration descriptive text strings and classifier text strings. The classifier text strings, in one embodiment, can define detected attributes detected with use of VLM 4502, e.g., action and pattern attributes. Manager system 110 can employ the generated text strings as candidate text strings for deployment in synthesized voice for augmentation of the current media stream. In another aspect, manager system 110 can employ the generated text strings as model prompting data for prompting one or more additional predictive model. In response to being queried with one or more video frame, e.g., video frame samples at frame sampling block 1105, VLM 4502 can output one or more candidate text description defining a string at string generating block 1108. In response to string generating block 1108, manager system 110 at store block 1109 can store output strings including the candidate text strings in strings area 2124 of data repository 108. In one aspect, based on the training of VLM 4502, the candidate text strings describe video of the current open time window.

Manager system 110 at frame sampling block 1105 can be configured to sample frames having a frame timestamp of about time 3104, the detected open time window commencement time detected at block 1102. At subsequent iterations of frame sampling block 1105 manager system 110 can select one or more video frame associated and timestamped to a corresponding later time within a detected open voice time window 3102.

Referring to time window determining block 1105, manager system 110 can predict the time period of an open time window in dependence on a detected attribute of a video scene associated of one or more current open time window being subject to characterizing.

Embodiments herein recognize that open time windows associated to a scene can be dependent on actions and/or patterns occurring within the scene. For example, a golf announcer (for purposes of emulating a live bystander) may not speak during the time when a golfer being represented in a media stream stands over a golf ball and the time that the golfer completes golf swing. A sporting event announcer, according to another example, may also remain silent when crowd reaction is being shown after a score. In another example, a baseball announcer may refrain from narrating a baseball game during the time that a baseball player moves from a batter box to a batter position at home plate. In another example, an announcer may refrain from speaking when a scene of a coach or manager is being shown. In another example, an announcer may refrain from speaking when a routine play is being made by a team, that is clearly discernible by viewing video data.

FIG. 4B depicts time window predictive model 4504 that can be trained with machine learning to predict a duration of an open time window in dependence on an attribute detected within a scene. Time window predictive model 4504 once trained can be responsive to model prompting data. Iterations of training data applied for training predictive model 4504 can include, e.g., an attribute (e.g., a detected action or pattern) applied as input training data and an associated historical observed open window duration time period associated to the attribute applied as outcome training data. Iterations of training data can also include as input training data scene parameter values, e.g., persons, teams. Time window predictive model 4504, once trained, can be responsive to model prompting data which model prompting data can comprise a current detected attribute detected within the current scene based on one or more frame selected at block 1105 during the most recent iteration of frame select block 1105. The current detected attribute can include a classification description, e.g., current pattern or action output by VLM 4502 at block 1108.

In response to being prompted with the described model prompting data predictive model 4504 can output a prediction as specifying the predicted duration of the current open time window being characterized.

Embodiments herein recognize that accurate predictions as to durations of time windows and accurate predictions as to the duration of presented descriptive text string presented in synthesized voice can improve the technology of media presentment. For example, where injection of supplementary voice data can be accurately timed with respect to determined time windows a user is more likely to comprehend subject matter being communicated with foreground voice data and supplementary voice data.

Manager system 110 in one aspect of style analyzing block 1110 can make use of one or more frame selected at block 1105. In one aspect, the one or more frame selected at block 1105 can produce prompting data for prompting sentiment predictive model 4506 as shown in FIG. 4C. FIG. 4C depicts sentiment predictive model 4506 that can be trained with machine learning to predict sentiment of current open time window in dependence on an attribute detected within a scene. Predictive model 4506 once trained can be responsive to model prompting data.

Iterations of training data applied for training sentiment predictive model 4506 can include as input training data sampled historical video data frame(s), attribute data (e.g., a detected action or pattern) of the frame(s), and domain parameter value(s) of the frame(s), e.g., persons, teams, places. Iterations of training data applied for training sentiment predictive model 4506 can include as outcome training data a sentiment vector. The sentiment vector labels can be applied by an administrator user according to one embodiment or can be collected with use processing configured to detect sentiment vectors from video including video representing facial expressions. Sentiment vector data can include polar sentiment data, e.g., scales of positive or negative sentiment and/or tonal sentiment data, e.g. scales of “anger,” “disgust,” “fear,” “joy,” and “sadness.”

Predictive model 4506, once trained, can be responsive to model prompting data which model prompting data can comprise, e.g., (a) one or more of, a currently sampled one or more frame, (b) a current detected attribute detected within the current scene based on one or more frame sampled at block 1105 during the most recent iteration of string generating block 1108. The current detected attribute can include a classification description, e.g., current pattern or action output by VLM 4502 at block 1108. The model prompting data can also include domain parameter values of the current open time window, e.g., as detected at block 1109, and expanded via lookup of referenced domain data within domains area 2129. Prompted as described, predictive model can output a predicted sentiment vector for a current scene associated to a current open time period being characterized. Sentiment predictive model 4506 in one use case can be trained to predict heightened sentiment in the event that game play advances to a critical juncture. In one example, a ball advancing proximate goal line can be detected as “goal position pattern” attribute indicative of an alert game event of a sports game by VLM 4502 (which has been fine tune-trained to detect such pattern), and training for sentiment predictive model 4506 can be provided with labeled data such that heightened sentiment is predicted when the “goal position pattern” has been detected. In one embodiment, sentiment predictive model 4506 has been trained with labeled training data associating certain sentiment (e.g., “joy” above 0.5) to the certain attribute, e.g., (the “goal position pattern”) and outputs a predicted sentiment based on prompting with the attribute currently detected, and manager system 110 can perform configuring acoustical characteristics of a synthesized voice segment (block 1115) in dependence on the predicted sentiment.

Accordingly, there is set forth herein, according to one embodiment, examining foreground voice data characterizing foreground voice period 3101 of a multimedia stream that includes a video stream data and an audio stream; identifying in dependence on the examining an open time window 3102 that is absent of foreground voice data characterizing foreground voice period 3101; processing, in dependence on the identifying, media stream data of multimedia stream; generating, in dependence on the processing, a text string for deployment in the open time window 3102, wherein the text string describes content of the video stream; converting the text string into a synthesized voice segment; and adapting the audio stream data so that the synthesized voice segment is included in the audio stream and time bounded within the open time window, wherein the processing media stream data of the multimedia stream includes recognizing based on processing video data of open time window, a certain attribute indicative of an alert game event of a sports game, prompting a sentiment predictive model, e.g., sentiment predictive model 4506 with use of the certain attribute, wherein the sentiment predicting machine learning model has been trained with labeled training data associating certain sentiment to the certain attribute, outputting a predicted sentiment based on the prompting, and configuring (block 1115) acoustical characteristics of the synthesized voice segment in dependence on the predicted sentiment.

Manager system 110 at style analyzing block 1110 can predict culture of a current scene and open time window being characterized. For predicting a culture of a current scene and current open time period, manager system 110 can query a predictive model of models area 2122 that has been trained with training data including iterations of training in which there has been applied, for each iteration of training, training data comprising (as input training data) detected patterns from and historical scene, and training data (as outcome training data) a culture label of the scene. Embodiments herein recognize that patterns, e.g., as represented in clothing, can be representative of culture, e.g., regional, national, historical culture. The culture label of the scene can specify, e.g., regional, national, historical culture. Query data for querying such a predictive model trained to detect culture can include pattern classification strings output by VLM 4502 during a most recent iteration of block 1108. Manager system 110 can also or alternatively derive a culture classification of the current open time period by processing of audio data, e.g., foreground voice data of “AA” or “BB” of FIG. 3A. In one embodiment, a culture classification can be based on accent detection. Manager system 110 can aggregate, e.g., average culture classification results based on different techniques.

Manager system 110 at style analyzing block 1110 can process audio data of the current media stream for determination of a sentiment associated to audio data of the current scene. For processing audio data, manager system 110 can select a recorded time period of the most recent foreground voice data, and/or can select background audio, e.g. crowd noise. In reference to the timing diagram of FIG. 3A, a media stream can be characterized by foreground voice periods 3101 featuring foreground voice data of one or more speaker, e.g., announcer, actor, separated by open time windows 3102. At style analyzing block 1110, manager system 110, manager system 110 can process voice data of the most recent and in some cases the most recent one or more foreground voice periods 3101. Thus, in the case in reference to FIG. 3A that manager system 110 is determining supplemental voice data for the open time window 3102 “A” commencing at time 3104, manager system 110 at style analyzing block 1110 can process voice data of the foreground voice period 3101 “AA” terminating at time 3104.

For extracting sentiment from voice data, manager system 110 can employ the decision data structure of Table A.

TABLE A

| | Fear | Anger | Sadness | Happiness | Disgust |
|---|---|---|---|---|---|
| Speech Rate | Much | Slightly | Slightly | Faster or | Very Much |
| | Faster | Faster | Slower | Slower | Slower |
| Pitch Average | Very Much | Very Much | Slightly | Much Higher | Very Much |
| | Higher | Higher | Lower | | Lower |
| Pitch Range | Much | Much Wider | Slightly | Much Wider | Slightly |
| | Wider | | Narrower | | Wider |
| Intensity | Normal | Higher | Lower | Higher | Lower |
| Voice Quality | Irregular | Breathy Chest | Resonant | Breathy | Grumbled |
| | Voicing | Tone | | Blaring | Chest Tone |
| Pitch Changes | Normal | Abrupt On | Downward | Smooth | Wide |
| (intonation) | | Stressed | Inflection | Upward | Downward |
| | | Syllables | | Inflections | Terminal |
| | | | | | Inflections |
| Articulation | Precise | Tense | Slurring | Normal | Normal |

Referring to Table B, manager system 110 can employ Table B to map acoustical characteristics of vocal utterances to exhibited sentiments. When using acoustic characteristics of vocal utterances to return sentiment classifications, manager system 110 can use speech profile data of domains area 2129. For example, speech profile data of domains area 2129 can include data specifying baseline characteristics of a certain person's speech, from which relative parameters can be returned, e.g., what is regarded to be “faster” speech can be determined in reference to a baseline speech rate for a particular person and therefore can be determined differently depending on which person is speaking.

On completion of an iteration of store block 1109, store block 1104, and style analyzing block 1110, manager system 110 can proceed to decision block 1111. At decision block 1111, manager system 110 can ascertain whether there is additional time to characterize one or more scene associated to a current open time period window. Referring to the timeline of FIG. 3A, given the duration of the time delay of the delayed media stream, the delayed live media stream in FIG. 4B, manager system 110 may have until the stop time 3108 in which to complete generation of candidate strings at block 1108 before which manager system 110 must proceed to selection of optimized text string in order to timely inject supplemental voice data into corresponding open time window 3102 of the delayed live stream of FIG. 3B commencing at time 3104.

Where the delayed live stream of FIG. 3B proceeds on a ten second delay, the stop time 3108 according to one example may be, e.g., eight seconds. However, in various embodiments, stop time 3108 can be adaptively determined, e.g., based on computing resource availability, processing speed, and/or other metrics. Further, while delayed live stream 3200 is described with reference to a ten second delay, delayed live stream may operate on a shorter delay, e.g., three seconds, in which case manager system 110 will have less time to deploy a selected text string.

On the determination that additional time for processing and characterizing is available (e.g., manager system 110 is at a time preceding time 3108 in the example depicted in FIG. 3A), manager system 110 can loop back to a stage prior to blocks 1105, 1103, and 1110 to complete the next iteration of the blocks 1105 to 1109, block 1103 to 1104 and block 1110.

Manager system 110 can iteratively perform the described loop until a time where it is determined at block 1110 that manager system 110 should proceed to string selection in order to timely inject supplemental voice data into the delayed live stream 3200 of FIG. 3B.

Manager system 110 on determining at block 1111 that additional time for open time window characterization is available, can return to a stage preceding blocks 1105, 1103, 1111 and 1110, and can iteratively perform the loop of blocks 1105 at 1109, 1103 to 1104, and 1110 iteratively until a time at block 1111, at which manager system 110 determines that additional time for open time window characterization is not available.

Embodiments herein recognize that manager system 110 can perform the open time window characterizing loop 1130 multiple times for a given open time window being subject to characterization. For example, with reference to the timing diagram of FIG. 3A, manager system 110 can perform a first iteration of time window characterizing loop 1130 commencing at time 3104, can perform and commence a second iteration of time window characterizing loop 1130 at time 3110 and commence the third iteration of open time period characterizing loop 1130 at time 3112. The number of iterations performed of time window characterizing loop 1130 can depend on a variety of factors, e.g., the duration of the time delay of delayed live stream 3200, computing resource availability, processing speed, model complexity, and the like. In some use cases, the time delay of delayed live stream 3200 can be sufficiently short to facilitate a single iteration of window characterizing loop 1130. In performing the multiple iterations of loop 1130, manager system 110 in some embodiments can discard open window characterizing data from prior iterations. In performing the multiple iterations of loop 1130, manager system 110 in some embodiments can aggregate open window characterizing data from prior iterations and can apply a weighting scheme to that later determined open window characterizing data is weighted more heavily.

In determining at block 1111 that additional time for commencing string selection is not available, manager system 110 can proceed to string select block 1112. Further, even where at block 1111 manager system 110 determines that additional time for string selection is not available, manager system 110 can nonetheless return to a stage preceding blocks 1105, 1103, 1111 and can iteratively continue to perform the open time window characterizing loop 1130 while simultaneously proceeding to string select block 1112.

At string select block 1112, manager system 110 can evaluate candidate text strings describing video data and can select a deployment descriptive text string from candidate text strings in dependence on multiple factors. In some embodiments, manager system 110 at select block 1112 can expand a number of candidate text strings prior to evaluating the candidate text strings. Manager system 110 expanding candidate text strings can include manager system 110 presenting model prompting data to one or more large language model (LLM) such as LLM 4508.

Referring to LLM 4508 of FIG. 4D, LLM 4508 can be provided by a foundational language model which has been subject to fine tuning training to define LLM 4508. Pre-training LLM 4508 using self-supervised learning can include various methods that utilize unlabeled data to generate useful representations. Methods can include, e.g., Masked Language Modeling (MLM), where random words in the text are masked and the model is trained to predict them, as used in BERT and/or Autoregressive Language Modeling, where the model predicts the next word in a sequence based on previous words, as seen in GPT. Next Sentence Prediction (NSP) can also or alternatively be employed, which trains the model to understand sentence relationships by predicting if one sentence follows another, also used in BERT. The described functions leverage the structure of the text itself to create learning objectives, enabling the model to learn contextual representations of language without requiring manually labeled data.

Fine tuning training of LLM 4508 as depicted in FIG. 4D can include subjecting LLM 4508 to supervised learning with use of iterations of fine tuning training data, wherein iterations of fine tuning training data can include as input data domain parameter values associated to an historical scene, detected scene attributes of an historical scene, and which can include as outcome data a text description of an historical scene that describes the scene. Trained as described, LLM 4508 can be responsive to model prompting data. Model prompting data for querying LLM 4508 can include for the current open time window being characterized, domain parameter values for the current domain, and attribute parameter values of a current scene of the open time window being characterized, e.g., pattern, action. The scene attribute parameter values of the current scene input into LLM 4508 as model prompting data can be scene output attribute parameter values output by VLM 4502, e.g., including detected action and/or pattern attributes as set forth in reference to FIG. 4A. Prompted as described, LLM 4508 can produce additional candidate text descriptions for evaluation as the deployed text string for fitting to the current open time window. In a further aspect multiple instances of LLM 4508 can be queried, each fine-tuned for a different domain.

The sample code of Table B depicts how any number of LLMs can be loaded by python code and executed to produce AI Narration.

TABLE B
import warnings
from transformers import AutoTokenizer, AutoModelForSeq2SeqLM, TrainingArguments, Trainer #,
DataCollatorWithPadding
import transformers as trans
from transformers.trainer_utils import get_last_checkpoint
import pytorch_lightning as pl
import torch
from fm_nlp.architecture.sandstone.hf_model import SandstoneHF
from data import dict2str
import cmsrc.main.com.ibm.ix.utils.Constants as Constants
from cmsrc.main.com.ibm.ix.context.Context import Context
from cmsrc.main.com.ibm.ix.nlpsystem import ModelDescriptions as ModelDescriptions
from data import DatasetBuilder, PbPDataCollatorForSeq2Seq, tokenize_function
from peft import get_peft_model
from peft.utils.hf_trainer_integ import load_MULTITASK_PREFIX_TUNING_model,
PrefixTuningTrainer
from peft import LoraConfig, TaskType
from eval import full_eval
from models import getPeftConfig
import evaluate
import logging
import os
logging.basicConfig(level=logging.INFO)
logger = logging.getLogger(_{——}name_{——})
warnings.filterwarnings(‘ignore’)
pl.seed_everything(0, workers=True)
class MPTModel( ):
def _{——}init_{——}(self):
super( )._{——}init_{——}( )
#i.e. TOKENIZER_TYPE=“sandstone”
if os.getenv(‘TOKENIZER_TYPE’) == Constants.SANDSTONE:
#i.e. TOKENIZER_SANDSTONE_TYPE=“t5-3b”
tokenizer = AutoTokenizer.from_pretrained(os.getenv(‘TOKENIZER_SANDSTONE_TYPE’))
tokenizer.add_special_tokens({‘sep_token’: ‘[SEP]’})
print(“Loaded sandstone tokenizer { }”.format(os.getenv(‘TOKENIZER_SANDSTONE_TYPE’)))
if ‘sandstone’ in os.getenv(‘MODEL_TYPE’):
#if os.getenv(‘MODEL_TYPE’) == Constants.SANDSTONE_BASE_MODEL:
#i.e. MPTMODEL_PATH=“/dccstor/dkim1/pretrained/flan/generic_basewatson_flan.pth”
model = SandstoneHF.from_pretrained(os.getenv(‘MPTMODEL_PATH’))
model.resize_token_embeddings(len(tokenizer))
print(“Loaded sandstone model { }”.format(os.getenv(‘MPTMODEL_PATH’)))
else:
raise Exception(“The system does not support TOKENIZER_TYPE { } and MODEL_TYPE
{ }.”.format(os.getenv(‘TOKENIZER_TYPE’),os.getenv(‘MODEL_TYPE’)))
else:
# #i.e. TOKENIZER_SANDSTONE_TYPE=“t5-3b”
tokenizer = AutoTokenizer.from_pretrained(os.getenv(‘TOKENIZER_TYPE’))
if os.getenv(‘MODEL_MAX_LENGTH’) is not None:
tokenizer.model_max_length = os.getenv(‘MODEL_MAX_LENGTH’)
tokenizer.add_special_tokens({‘sep_token’: ‘[SEP]’})
#i.e. TRAINING_TYPE=“peft”
if os.getenv(‘TRAINING_TYPE’) == Constants.PEFT:
logger.info(“Loading PEFT type model { } from checkpoint
{}.”.format(os.getenv(‘MPTMODEL_PATH’),os.getenv(‘MODEL_CHECKPOINT’)))
model =
AutoModelForSeq2SeqLM.from_pretrained(pretrained_model_name_or_path=os.getenv(‘MPTMODE
L_PATH’))
model.resize_token_embeddings(len(tokenizer))
logger.info(“Loaded base model.”)
logger.info(“Retrieving PEFT with tokens { } and encoder prompting
{ }”.format(Context.CONFIG[‘model_inference’][‘nPrompts’],Context.CONFIG[‘model_inference’][‘enc
oder_prompting’]))
if ‘flan-t5-xl’ in os.getenv(‘MPTMODEL_PATH’):
peft_config = getPeftConfig(‘google/flan-t5-xl’,
nVirtToks=Context.CONFIG[‘model_inference’][‘nPrompts’],
encoder_prompting=Context.CONFIG[‘model_inference’][‘encoder_prompting’])
else:
peft_config = getPeftConfig(os.getenv(‘MODEL_TYPE’),
nVirtToks=Context.CONFIG[‘model_inference’][‘nPrompts’],
encoder_prompting=Context.CONFIG[‘model_inference’][‘encoder_prompting’])
logger.info(“Retrieved peft_config.”)
model = get_peft_model(model, peft_config)
logger.info(“Loaded PEFT model”)
model.print_trainable_parameters( )
TrainerClass = PrefixTuningTrainer #PbPTrainer
trans.trainer.WEIGHTS_NAME = os.getenv(‘PREFIX_WEIGHT_FILE’)
if len(os.getenv(‘MPTMODEL_PATH’))>0:
logger.info(“Loading prefixes”)
load_result = load_MULTITASK_PREFIX_TUNING_model(model,
os.getenv(‘MODEL_CHECKPOINT’))
logger.info(“Loaded prefixes”)
else:
model = AutoModelForSeq2SeqLM.from_pretrained(os.getenv(‘MPTMODEL_PATH’))
model.resize_token_embeddings(len(tokenizer))
if os.getenv(‘TRAINING_TYPE’) == Constants.PEFT:
if os.getenv(‘LORA_R’) is None or int(os.getenv(‘LORA_R’)) == 0:
peft_config = getPeftConfig(os.getenv(‘MODEL_TYPE’),
nVirtToks=Context.CONFIG[‘model_inference’][‘nPrompts’],
encoder_prompting=Context.CONFIG[‘model_inference’][‘encoder_prompting’])
print(“Retrieved model type peft”)
else:
peft_config = LoraConfig(task_type=TaskType.SEQ_2_SEQ_LM, inference_mode=False, r=8,
lora_alpha=32, lora_dropout = 0.1, target_modules = os.getenv(‘LORA_TARGET’).split(‘_’))
print(“Retrieved lora peft”)
model = get_peft_model(model, peft_config)
model.print_trainable_parameters( )
trans.trainer.WEIGHTS_NAME =os.getenv(‘PREFIX_WEIGHT_FILE’)
if os.getenv(‘MODEL_CHECKPOINT’) is not None:
if os.getenv(‘LORA_R’) is None or int(os.getenv(‘LORA_R’)) == 0:
load_result = load_MULTITASK_PREFIX_TUNING_model(model,
os.getenv(‘MODEL_CHECKPOINT’))
else:
model2load = os.getenv(‘MODEL_CHECKPOINT’).split(‘#’)
if len(model2load) == 1:
from peft.utils.hf_trainer_integ import_load_from_checkpoint
load_result = _load_from_checkpoint(os.getenv(‘MODEL_CHECKPOINT’), model)
else:
from models import multi_lora_load_from_checkpoints
model2load = [x.split(‘@’) for x in model2load]
model2load = [(x[0] if len(x)==1 else x) for x in model2load]
multi_lora_load_from_checkpoints(model2load, model)
print(“Finished loading model and tokenizer”)
self.model = model
self.tokenizer = tokenizer
def instruction_tuning(self):
print(‘Loading the { } dataset’.format(Context.CONFIGS[‘model_training’][‘train_set’]))
def getPeftConfig(model_name: str, nVirtToks: int=100, encoder_prompting: bool=False):
if model_name == ‘google/flan-t5-large’:
# #https://huggingface.co/google/flan-t5-large/blob/main/config.json (when HF is installed editable
under lib, we can probably find those files according to model name)
peft_config = MultitaskPrefixTuningConfig(
encoder_prompting=encoder_prompting,
peft_type=PeftType.MULTITASK_PREFIX_TUNING,
task_type=TaskType.SEQ_2_SEQ_LM,
num_virtual_tokens=nVirtToks,
token_dim=1024,
num_transformer_submodules=2,
num_attention_heads=16,
num_layers=24,
encoder_hidden_size=1024)
elif model_name == ‘google/flan-t5-base’:
# https://huggingface.co/google/flan-t5-base/blob/main/config.json (when HF is installed editable
under lib, we can probably find those files according to model name)
peft_config = MultitaskPrefixTuningConfig(
encoder_prompting=encoder_prompting,
peft_type=PeftType.MULTITASK_PREFIX_TUNING,
task_type=TaskType.SEQ_2_SEQ_LM,
num_virtual_tokens=nVirtToks,
token_dim=768,
num_transformer_submodules=2,
num_attention_heads=12,
num_layers=12,
encoder_hidden_size=768)
elif model_name == ‘google/flan-t5-xl’:
# https://huggingface.co/google/flan-t5-xl/blob/main/config.json (when HF is installed editable under
lib, we can probably find those files according to model name)
peft_config = MultitaskPrefixTuningConfig(
encoder_prompting=encoder_prompting,
peft_type=PeftType.MULTITASK_PREFIX_TUNING,
task_type=TaskType.SEQ_2_SEQ_LM,
num_virtual_tokens=nVirtToks,
token_dim=2048,
num_transformer_submodules=2,
num_attention_heads=32,
num_layers=24,
encoder_hidden_size=2048)
elif model_name == ‘facebook/bart-large’:
# https://huggingface.co/facebook/bart-large/blob/main/config.json (when HF is installed editable
under lib, we can probably find those files according to model name)
peft_config = MultitaskPrefixTuningConfig(
peft_type=PeftType.MULTITASK_PREFIX_TUNING,
task_type=TaskType.SEQ_2_SEQ_LM,
num_virtual_tokens=nVirtToks,
token_dim=1024,
num_transformer_submodules=2,
num_attention_heads=16,
num_layers=12,
encoder_hidden_size=1024)
elif model_name == ‘facebook/bart-base’:
# https://huggingface.co/facebook/bart-large/blob/main/config.json (when HF is installed editable
under lib, we can probably find those files according to model name)
peft_config = MultitaskPrefixTuningConfig(
peft_type=PeftType.MULTITASK_PREFIX_TUNING,
task_type=TaskType.SEQ_2_SEQ_LM,
num_virtual_tokens=nVirtToks,
token_dim=768,
num_transformer_submodules=2,
num_attention_heads=12,
num_layers=6,
encoder_hidden_size=3072)
else:
raise ValueError(f‘Unsupported model: {model_name}’)
return peft_config

Manager system 110 at block 1112, in one embodiment, can employ Eq. 1 presented below for evaluation of candidate text strings that can describe video content of an open time window.

S1=F1W1+F2W2+F3W3+F4 (Eq. 1)

Referring to Eq. 1, S can be an overall score for candidate descriptive text string, F1, F2, F3, and F4 can be factors for evaluation and W1, W2, W3, and W4 can be weights associated to the respective factors F1, F2, F3, and F4.

Manager system 110 can evaluate multiple factors in selecting a production text string describing video data associated to an open time window. Factor F1 can be a time matching time window matching factor. Manager system 110 for scaling scoring values under factor F1 can scale scoring values in dependence comparison between a current determined open time window duration determined at the last iteration of block 1103 to a predicted time for presentment of the candidate text string being evaluated at string selection block 1112. Manager system 110 can scale values toward high valued scoring values approaching 1.0 where a predicted time for presentment of the text string closely matches but is less than the predicted duration of the open time window by targeted duration (short pauses between foreground and supplemental voice data can be targeted).

Manager system 110 can scale downward scoring values applied under factor F1 where the predicted time for presentment of the candidate text string being evaluated is larger than the predicted duration of the open time window. Manager system 110 can apply a disqualifying high negative value, under scoring the factor F1 where a predicted time period for presentment of a candidate text string exceeds the determined time duration for an open time window by a threshold duration of time, thus eliminating the described candidate text string.

In some use cases a voice synthesizer for rendering the candidate text string can include emulation mode functionality to predict time for rendering in dependence on an input text string and rendering effects which can be a function of determined style of an open time window being characterized. Manager system 110 can query such an interface for predicting rendering time when evaluating a candidate text string under Factor F1. Additionally, or alternatively, manager system 110 can employ alternate methodologies for predicting rendering time.

In one simplified embodiment, manager system 110 can employ decision data structure as shown in table A for evaluating factor F1 for performance of string selection block 1112. Referring to Table A, the decision data structure of Table A correlates syllables of a candidate text string to predicted times associated to the various syllables counts. The time durations assigned in Table A can be assigned by, e.g., by an administrator or heuristically by examination of history data stored in data repository 108.

TABLE C

| Number of | Predicted time duration for |
|---|---|
| syllables | presentment of text string |
| . . . | . . . |
| 4 | XX seconds |
| 5 | XX seconds |
| 6 | XX seconds |
| . . . | . . . |

Additionally or alternatively, manager system 110 at string select block 1112 when evaluating factor F1 can employ the rendered text string duration predictive model 4510 of FIG. 4E. FIG. 4E describes a predictive model that has been trained with iterations of training data to predict a duration of a presented text string based on a variety of input parameters. Training data for training predictive model 4510 as shown in FIG. 4D can include as input training data, e.g., the presented text string of the historical instance of the presented text string, the number of syllables of the presented historical text string, style parameters of the historical text string (the determined style parameters associated to the historical open time window). Training data for training predictive model 4510 as shown in FIG. 4E can include as outcome training data the historical observed duration of the historically presented text string. Trained as described, predictive model 4510 can be responsive to model prompting data where model prompting data can include a specifier, e.g., of the currently determined style of the current open time window being characterized, e.g., as determined during the most recent iteration of style analyzing block 1110, the text string currently being evaluated at string select block 1112, and the number of syllables of the current candidate text string being evaluated using Eq. 1. With the prompting data applied as described, the predictive model of FIG. 4F can output a prediction as to the duration of presented text string when presented in synthesized voice. If the described predictive model 4510 of FIG. 4E has not been trained with sufficient iterations of specific text strings, the predictive model 4510 of FIG. 4E may nevertheless be expected to output satisfactory predictions based on training in regard to number of syllables.

Now referring further to Eq. 1, manager system 110 in evaluating factor F2 can assign scoring values under factor F2 in dependence on a comparison of the style of the candidate text string being evaluated to a style of the characterized open time window as determined during the most recent iteration of style analyzing block 1110. Manager system 110 in evaluating under factor F2 can scale scoring values in dependence on the degree to which the determined style of the candidate text string matches style of the characterized open time window as determined during the most recent iteration of style analyzing block 1110. For generating a style vector for the candidate text string, manager system 110 can subject the candidate text string in order to generate a sentiment vector specifying degree of positive, negative or neutral sentiment, and a tonal sentiment vector specifying levels of “anger,” “disgust,” “fear,” “joy,” and “sadness”. A sentiment vector determined for an open current open time window can be performed at style analyzing block 1110, e.g., by deriving a sentiment vector by video data of frame of one or more frame selected at block 1105 and/or for audio data as may be determined by processing foreground audio preceding time 3104 using speech to text conversion and acoustical characteristic processing as described in Table B. Manager system 110 can further scale scoring values under factor F2 in dependence on a determination of culture match with respect to the culture determination by manager system 110 at the most recent iteration of block 1110. For example, manager system 110 can bias a scoring value upward under factor F4 where the evaluated text string employs vocabulary and/or grammar consistent with a determined regional or historical period culture and can bias a scoring value downward under factor F4 where the evaluated text string does not employ vocabulary and/or grammar consistent with a determined regional or historical period culture.

Manager system 110 assigning scoring values under factor F3 of Eq. 1 can apply scoring values in dependence on a degree to which the semantic meaning of the candidate text string being evaluated is differentiated from the semantic meaning of one or more foreground voice data segment proximate the open time window being evaluated. For performing evaluation under factor F4, manager system 110 can compare a semantic meaning vector representation of the candidate string being evaluated to a semantic meaning vector representation of one or more foreground voice segment proximate the open time window being evaluated. In reference to FIG. 3B, the open time window being evaluated can be the open time window at ‘A’ and the one or more foreground voice segment can be the voice segment at ‘AA’.

Manager system 110, in one embodiment, can employ word2vec predictive model 4512 as set forth in FIG. 4F for determination of vector representation of a word. For performance of evaluating under factor F4, manager system 110 can convert audio data of a speaker associated to the foreground voice data to voice-to-text processing so that resulting text resulting from the conversion can be input into word2vec predictive model 4512 for return of a vector representation of a word defining a string. Manager system 110 can employ word2Vec predictive model 4512 to determine similarity between multi-word strings by aggregating the word embeddings into a single vector representation for each multi-word string. Manager system 110 according to one example can perform preprocessing of the sentences to tokenize them and remove stop words, then average the word2vec embeddings of the remaining words to create a multi-word-level embedding. With multi-word level embeddings established, manager system 110 can compare the embeddings, e.g., based on Euclidian distance.

Factor F3 can be regarded to be a redundancy check factor. Embodiments herein recognize that engagement of a user to a presented media stream can be enhanced where subject matter of supplemental voice data is differentiated from subject matter of a foreground voice data. That is, embodiments herein recognize that it can be highly distractive, and the user may lose engagement where the semantic meaning of injected supplemental voice data is redundant to the semantic meaning of foreground voice data contemporaneously presented to a user. For example, where an announcer at the foreground voice data period terminating at time 3104 says “Tiger Woods has stepped onto the tee box” the supplemental voice data injected in the delayed media stream corresponding to the open time window, commencing at time 3104 should not also specify that Tiger Woods has stepped onto the tee box.

Manager system 110 assigning scoring values under factor F3 can assign a disqualifying high negative score (e.g., −999) where manager system 110 determines that a semantic meaning of a candidate string has alert threshold satisfying level of similarity with a semantic meaning of a contemporaneous foreground voice string, e.g., the string at ‘AA’ or ‘BB” as depicted in FIG. 3A as replicated in the stream instance of FIG. 3B (subsequent foreground voice strings can be processed, e.g., in the case of a recorded stream, or if the delay of stream 3200 is sufficiently long). According to one configuration, manager system 110 can scale scoring values above a baseline value where a similarity of the candidate string satisfies a baseline threshold but does not satisfy the described alert threshold but can scale scoring values below the baseline value where the similarity does not satisfy the baseline threshold. Embodiments herein recognize that users may be more engaged where the injected artificial text has some contextual connection to the foreground voice data. Other configurations may advantageously drive different results. Accordingly, in reference to factor F3, there is set forth herein, according to one embodiment, examining foreground voice data characterizing foreground voice period 3101 of a multimedia stream that includes a video stream data and an audio stream; identifying in dependence on the examining an open time window 3102 that is absent of foreground voice data characterizing foreground voice period 3101; processing, in dependence on the identifying, media stream data of multimedia stream; generating (block 1112 and/or block 1114), in dependence on the processing, a text string for deployment in the open time window 3102, wherein the text string describes content of the video stream; converting the text string into a synthesized voice segment; and adapting the audio stream data so that the synthesized voice segment is included in the audio stream and time bounded within the open time window, wherein the generating, in dependence on the processing, the text string for deployment in the open time window includes evaluating text string data of the text string according to a semantic meaning redundancy factor, and qualify the text string data for deployment responsively to a determination that a sematic meaning of the text string data is not redundant to a semantic meaning of foreground voice data associated to the open time window.

Manager system 110 assigning scoring values under factor F4 can include manager system 110 scaling scoring values in dependence on the degree to which the candidate text string being evaluated emulates a radio broadcast narration. Embodiments herein recognize that radio broadcasts tend to be “more colorful” than television broadcasts as announcers tend to call out details not plainly visible by observation of video data, based on the awareness that radio listeners do not have access to a video feed.

Manager system 110 can employ radio broadcast emulation predictive model 4514 as shown in FIG. 4G in order to predict a degree to which a candidate text string emulates a radio broadcast. Radio broadcast emulation predictive model 4514 can be trained with training data of historical instances of voice strings of broadcasts (radio or television) and once trained, is able to return predictions as to whether a hypothetical text string emulates a radio string or a television string. Radio broadcast herein refer to broadcasts that are audio only, and television broadcasts refer to broadcasts that are audio and video.

Voice to text conversion can be performed on historical broadcasts to collect training data. Iterations of training data for training radio broadcast emulation predictive model 4514 can include, as input data, a semantic meaning vector representation of the historical string (obtained using the technique described in connection with word2vec predictive model 4512), and domain parameter value(s). Training data can also include, as outcome data in the described supervised learning training, broadcast type classifier (radio or television). Once trained, predictive model 4514 can respond to model prompting data. Model prompting data for prompting predictive model 4514 can include the semantic meaning vector representation of the candidate text string (obtained using the technique described in connection with word2vec predictive model 4510). Predictive model 4514 can output a confidence level specifying that candidate text string emulates a radio broadcast, and a confidence level specifying that candidate text string emulates a television broadcast. Manager system 110 can scale scoring values under factor F4 in dependence on a degree to which the text string is predicted to emulate a radio broadcast (factor F4 scores can increase as the radio broadcast confidence level increases). Accordingly, in reference to Factor F4, there is set forth herein, according to one embodiment, examining foreground voice data characterizing foreground voice period 3101 of a multimedia stream that includes a video stream data and an audio stream; identifying in dependence on the examining an open time window 3102 that is absent of foreground voice data characterizing foreground voice period 3101; processing, in dependence on the identifying, media stream data of multimedia stream; generating (block 1112 and/or block 1114), in dependence on the processing, a text string for deployment in the open time window 3102, wherein the text string describes content of the video stream; converting the text string into a synthesized voice segment; and adapting the audio stream data so that the synthesized voice segment is included in the audio stream and time bounded within the open time window, wherein the generating, in dependence on the processing, the text string for deployment in the open time window includes performing evaluating of text string data of the text string according to an audio-only broadcast emulation factor, wherein the performing evaluating includes determining a degree to which a semantic meaning of the text string data emulates an audio-only broadcast.

In reference to Eq. 1, there is set forth herein, according to one embodiment, examining foreground voice data characterizing foreground voice period 3101 of a multimedia stream that includes a video stream data and an audio stream; identifying in dependence on the examining an open time window 3102 that is absent of foreground voice data characterizing foreground voice period 3101; processing, in dependence on the identifying, media stream data of multimedia stream; generating (block 1112 and/or block 1114), in dependence on the processing, a text string for deployment in the open time window 3102, wherein the text string describes content of the video stream; converting the text string into a synthesized voice segment; and adapting the audio stream data so that the synthesized voice segment is included in the audio stream and time bounded within the open time window, wherein the processing media stream data of the multimedia stream includes processing media stream data to predict (i) a time duration of the open time window, (ii) a sentiment of the open time window, and (iii) a semantic meaning of foreground voice segment data associated to the open time window, wherein the generating, in dependence on the processing, the text string for deployment in the open time window includes selecting the text string to (a) match the time duration of the open time window, (b) match the sentiment of the open time window, and (c) avoid redundancy with the semantic meaning of foreground voice segment data associated to the open time window, wherein the generating, in dependence on the processing, the text string for deployment in the open time window includes (1) obtaining one or more video data frame timestamped about a time of the open time window, and (2) applying the one or more video data frame timestamped about a time of the open time window as model prompting data to a visual language model (VLM) 4502 that has been trained with iterations of training data, wherein the iterations of training data include historical frame data labeled with descriptive text, (3) obtaining output text output from the VLM responsively to the applying, (4) prompting a large language model (LLM) using the output text output from the VLM, (5) evaluating VLM-output text strings output by the LLM responsively to the prompting as candidate text strings for deployment in the open time window, wherein the VLM-output text strings include the text string, and (6) selecting the text string from the candidate text strings based on the evaluating, wherein the evaluating includes a time window fitment evaluation factor, a style matching factor, and a factor that includes evaluation of a semantic meaning of the candidate text strings.

On completion of scoring all candidate text strings, manager system 110 can at block 1112 select the highest scoring text string for deployment to an open time window, and on completion of string selection, manager system 110 can proceed to decision block 1113.

At decision block 1113, manager system 110 can determine whether a trimming criterion is satisfied. One criterion can be that the current time window being characterized is not of a certain known time window duration. Referring to the timing diagram of FIG. 3A, embodiments herein recognize that where an iteration of window determining block 1103 is performed at time 3112, manager system 110 can be unable to ascertain the precise time of the open time window 3104, commencing at time 3104 and therefore can output a predicted time duration of the described time window.

However, where window determining block 1103 is performed at time 3114, manager system 110 is on the other hand able to produce a precise determination of the duration of the time window 3102, commencing at time 3104 based on the fact that the time window 3102, commencing at time 3104 has terminated at block 3106 which occurs before time 3114. Referring to block 1113, embodiments herein recognize that the open time window 3102 can have a duration longer than a duration of the time delay of delayed live stream of FIG. 3B, which can be more commonly be expected to be the case where configuration data adapts a time delay of delayed live stream 3200 to a shorter delay. As such, manager system 110 can rely on predictions as to the duration of the time window 3102 at “B” for each iteration of window determining block 1103 at which duration of time window 3102, commencing at time 3116 is determined.

Various additional or alternative criterion can be employed by manager system 110 at trimming decision block 1113 in deciding whether to perform trimming a trimming block 1114. One criterion can be that a confidence level associated to a prediction output by time window predictive model 4504 has satisfied a threshold. The confidence level associated to a prediction output by time window predictive model 4504 can be dependent on a volume of training data used to train time window predictive model 4504.

One criterion employed by manager system 110 at trimming decision block 1113 can be that the selected text string selected at 1112 exhibits a threshold level of duration similarity with the predicted duration of the open time window being subject to augmentation.

Another criterion can be that predicted duration of the open time window, being subject to augmentation has been reduced at block 1103 relative to a predicted duration returned to most recent prior iteration of window determining block 1103. When trimming is triggered at block 1114, manager system 110 can apply one or more methodologies for performing trimming of a duration of a text string. Zero or more of the described trimming criterion can be active during a current media streaming session depending on the configuration, and in one embodiment the respective criterion can be dynamically activated or deactivated based on sensed patterns and/or actions as output at iterations of block 1108.

Where manager system 110 at block 1113 determines that one or more trimming criterion are not satisfied, manager system 110 can proceed to voice synthesizing block 1115 without trimming.

Where manager system 110 determines at trimming criterion decision block 1113 that one or more active trimming criterion is satisfied, manager system 110, manager system can proceed to trimming at trimming block 1114.

Referring to trimming block 1114, manager system 110, where certain conditions apply, can trim a selected text string selected a block 1112 for assurance that a presented text string when presented in synthesized voice does not overlap in ensuing foreground voice data period. At trimming block 1114, manager system 110 can trim the time duration period of the text string so that presentment of the text string in synthesized voice is shortened in duration.

In one embodiment, manager system 110 can perform part of speech tagging on the selected text string selected for deployment at block 1112 and can trim, i.e., remove the last word or words of a text string based on a determination that the last word or words are of a certain predetermined classification of parts of speech.

In another use case scenario, manager system 110 at trimming block 1114 can move one or more word at the end of a text string independent of any determination of parts of speech for words of the text string.

In one embodiment, manager system 110 at trimming block 1114 can extract and store one or more word at the end of the selected text string selected at block 1112 into word buffer 2130 of data repository 108. Manager system 110 can retrieve the one or more word from word buffer 2130 of data repository 108 for presentment in synthesized voice at a successive open time period of a current media stream.

In reference to the timeline of FIGS. 3A and 3B, manager system 110 at trimming block 1114 can store into word buffer 2130 an extracted one or more word at the end of a text string for selected for insertion into an open time window at ‘A’ and can retrieve for presentment the stored one or more word in synthesized voice at the ensuing successive open time window at ‘B’.

On completion of trimming block 1114, manager system 110 can proceed to voice synthesizing block 1115. At voice synthesizing block 1115, manager system 110 can synthesize selected text string selected at block 1112 in synthesized voice.

For performing voice synthesizing block 1115, manager system 110 can select a sentiment for the synthesized voice that matches the sentiment of the current open time period being characterized based on performance of the last most recent iteration of block 1110. In one embodiment, manager system 110 can retrieve from styles area 2126 a most recent tonal sentiment vector determined for the current open time window being characterized, and manager system 110 can configure the acoustical characteristics of the synthesized speech, e.g., in terms of pitch, articulation, etc., to match the extracted sentiment vector. Manager system 110 can aggregate sentiment vectors for the current time window where multiple sentiment vectors are available. For performing voice synthesizing block 1115, manager system 110 can further configure the synthesized voice so that the synthesized voice, e.g., by selection of a certain accent, matches a determined culture of the current open time period being characterized based on performance of the most recent iteration of block 1110. For performing voice synthesizing block 1115 according to some embodiments, manager system 110 can further configure the synthesized voice so that the synthesized voice matches a determined acoustical profile of the current open time window, e.g., the acoustical profile determined with respect “AA” of FIGS. 3A and 3B wherein the open time window ‘A’ is being characterized. The acoustical profile can specify one or more of speech rate, pitch average, pitch range, intensity, voice quality, pitch changes (intonation), and articulation as specified in Table A and can further include, e.g. prosody.

On completion on voice synthesizing block 1115, manager system 110 can proceed to modify block 1116. At modify block, manager system 110 can modify the delayed live media stream depicted in FIG. 3B so that the delayed media stream includes supplemental voice data modified to include supplemental voice data within time window 3102 with commencement time 3104 replicating the original live media stream of FIG. 3A, having time window 3102 with commencement time 3104. Modifying at block 1116 can include manager system 110 encoding synthesized voice data produced at block 1115 into audio data of the delayed media stream depicted in FIG. 3B.

On completion of modify block 1116, manager system 110 can proceed to send block 1117. At send block 1117, manager system 110 can send the augmented media stream, augmented to include supplemental voice data, i.e. the media stream depicted in FIG. 3B. In response to receipt of the media stream, the media stream can be played back at playback block 1502 of UE devices associated to end-users who have elected with command data sent at block 1501 the augmented audio stream option.

At completion of modify block 1116, manager system 110 can simultaneously proceed to store block 1119 to store time window characterizing parameter values associated to the open time window just characterized. Time window characterizing parameter values can include e.g., observed open time window periods and recorded actions, patterns, foreground voice segments associated to such observed open time windows, selected text string and voice synthesizing control parameter values associated thereto, and any detected domain entity parameter value, e.g., person defining parameters, detected teams, detected speakers including announcers, and the like.

At training block 1120, manager system 110 can train one or more predictive model 4502, 4504, 4506, 4508, 4510, 4512, 4514 using training data defined by the open time window characterizing parameter values stored at store block 1119. Accordingly, a next time (even during a current media stream) that a relied upon predictive model is prompted (queried) for return of prediction data, the accuracy of the returned prediction can be expected to be improved by the training performed at training block 1120. Embodiments herein recognize the especially given the volume of data generated during a live stream event, and dependency of various of the parameters on in-session data (e.g., time window delay dependency on a particular announcer) the described training can significantly advance the accuracy of system 100 during a deployment period of a stream. Accordingly, there is set forth herein, according to one embodiment, examining foreground voice data characterizing foreground voice period 3101 of a multimedia stream that includes a video stream data and an audio stream; identifying in dependence on the examining an open time window 3102 that is absent of foreground voice data characterizing foreground voice period 3101; processing, in dependence on the identifying, media stream data of multimedia stream; generating (block 1112 and/or block 1114), in dependence on the processing, a text string for deployment in the open time window 3102, wherein the text string describes content of the video stream; converting the text string into a synthesized voice segment; and adapting the audio stream data so that the synthesized voice segment is included in the audio stream and time bounded within the open time window, wherein the method includes identifying an announcer associated to the foreground voice data, pulling supplemental domain data of the announcer (domains area 2129) responsively to the identifying, prompting a neural network machine learning model, e.g., predictive model 4504 using the supplemental domain data, predicting a duration of the open time window based on an output of the predictive model from the prompting, selecting the text string in dependence on the predicted duration, recording data specifying an actual duration of the open time window 3102, further training the neural network machine learning model using the recorded data specifying the actual duration of the open time window, discovering a subsequent open time window 3102 during streaming of the multimedia stream, re-prompting the neural network machine learning model responsively to the discovering, and predicting a duration of the subsequent open time window 3102 in dependence on the further training.

On completion of send block 1117, manager system 110 can proceed to stream end determination block 1118. Manager system 110 can iteratively perform the described loop of block 1102 to 1118 for a time that streaming of the described media set forth in reference to streaming block 1101 is active. On determining that a current stream has not ended, manager system 110 can return to stage preceding block 1102 in order to continue to identify open time windows within the original live media stream as depicted in FIG. 3A. On determination at block 1118 that the end of the stream has been reached, manager system 110 can proceed to return block 1121 and at return block 1121 can return to stage preceding block 1101 to wait for next command data to be received.

Camera devices 130A-130Z can iteratively perform the loop of block 1301 to block 1302 for deployment period of camera devices 130A-130Z. Audio input devices 140A-140Z can iteratively perform the loop of blocks 1401 to 1402 for a deployment period of audio input devices 140A-140Z. UE devices 150A-150Z can iteratively perform the loop of blocks 1501 to 1503 for deployment period of UE devices 150A-150Z. For a time that streaming at block 1101 is active, manager system 110 can iteratively return to a stage preceding open window commencement detection decision block 1102. In the case that streaming at block 1101 is terminated, manager system 110 can return to a stage preceding block 1101 wait for activation of next streaming at block 1101. Manager system 110 can be performing multiple instances of the loop of block 1101 to block 1118 concurrently.

Disclosed is the capability to use AI driven LLM technology, such as bidirectional encoder representations from transformers (BERT) to create audio description voiceovers in produced broadcast audiovisual programs. Audio description herein refers to a method for conveying visual information through audible narration of descriptive language to persons without access to visual content, e.g., sight impaired individuals, multitasking individuals, radio listeners and the like. Embodiments herein recognize that in any given video program, there are gaps in the dialog, where short descriptive verbiage may be introduced to convey information to sight-impaired individuals. Embodiments herein can employ audio description in a didactic fashion to teach neurodivergent individuals the subtlety of focusing on what is important.

Embodiments herein recognize that one challenge to delivering an audio description performance is to find the descriptive words that succinctly convey the visual context in a manner that fits the available “empty” spaces, e.g., variable time windows, where dialog is not present. Embodiments herein provide the possibility to split a recitation across multiple consecutive opportunity windows.

Embodiments herein recognize that an acceptable audio description performance can be one where the voiceover does not overlay the main dialog. An exceptional Audio Description performance is one where the delivery of the voiceover matches the style of the main performance. For instance, in a period piece the voiceover can employ language typical of the period, and the location, of the audiovisual program.

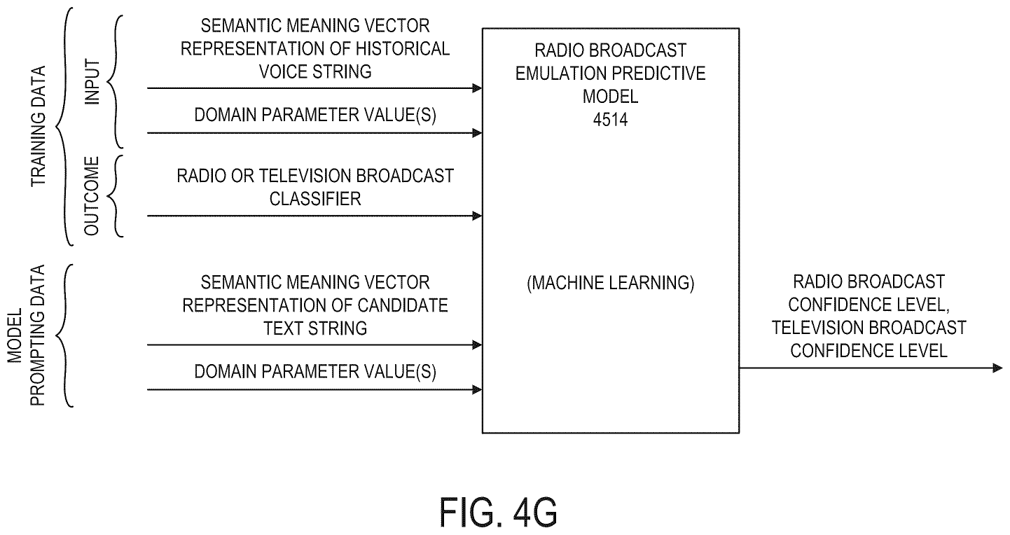

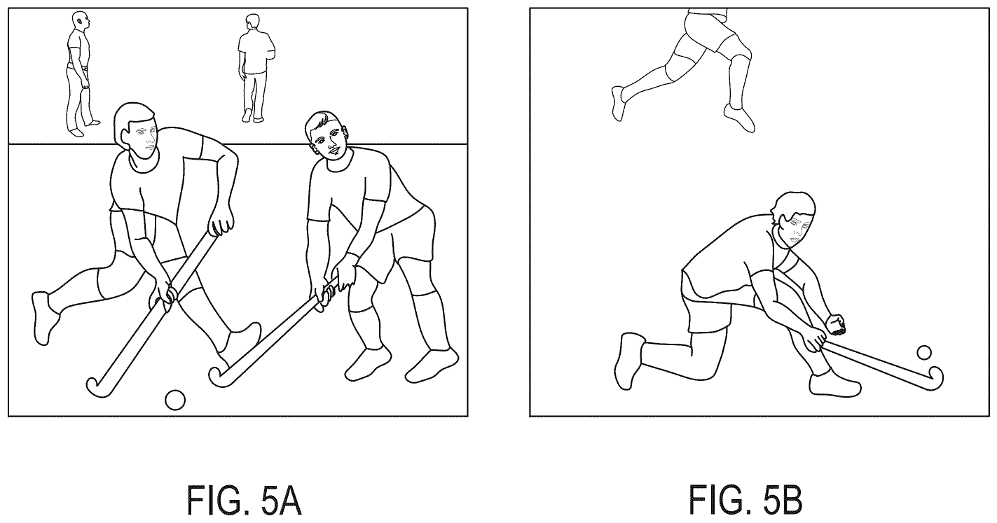

To create a compelling Audio Description performance, there are multiple sub-problems that an AI engine can resolve to produce a benefit. In one aspect, the visual context can be extracted, e.g., using a visual language model (VLM) such as VLM 4502 shown in FIG. 4A, which can extract, e.g. “player playing field hockey” from the image of FIG. 5A and can extract “player shoots” from the image of FIG. 5B.

In one aspect, a large language model (LLM) such as LLM 4508 can be used to generate an underlying narrative from the several images. In so doing the description of the image of FIG. 5B (where timed to a detected open time window) can specify, e.g., “Jones shoots on goal”.

In one aspect, constraint fitment methods can be applied to the appropriate description that fits the available time window. For instance, the available time window might allow the description of the image of FIG. 5B to be “Jones shoots on goal from mid-field”.

In one aspect, after the text for the description has been settled on, embodiments herein can benefit from synthesizing and audibly performing the text, in a consistent manner consistent with a remaining of a presentation. Matching audio description to an audiovisual program can include selecting text and synthesizing controls to match style of the program. Matching style can include, e.g., matching detected sentiment, speech pattern, and culture (including periodicity) of the program.

Embodiments herein can provide a coherent Audio Description of arbitrary length spread over an arbitrary number of quips that can be overlaid over existing produced audiovisual program.

Embodiments herein can provide live, near real-time, context-sensitive audio descriptions for live and recorded video content to assist visually impaired and neurodivergent individuals, and other persons without access to video, without disrupting existing dialogue. Embodiments herein can employ artificial intelligence to analyze visual content, create tailored audio narratives, and seamlessly inject them into the appropriate gaps in the audio track of the video.

Embodiments herein can provide AI audio narrative injection to produced videos providing additional commentary, statistics, information and references to enhance the video stream. Embodiments herein enhance the viewing experience and to provide situational awareness for people with visual impairments.

According to embodiments herein, AI generated audio narrative can be added to variable length narrative across multiple intervention open time windows in a video stream to provide context in dependence on a sequence of images using AI visual and language models.

According to embodiments herein, produced AI narrations can be correlated with the existing sounds within a video. According to one embodiment, channels of context can be produced at different sound and visual samples that are related by a polynomial equation.

Embodiments herein can automate the generation and insertion of audio descriptions within non-live video streams for the benefit of persons without access to video, e.g., including sight-impaired individuals and neurodivergent individuals learning to focus on important audio cues, multitasking persons, radio listeners and the like. Embodiments herein can leverage artificial intelligence-driven language and video models to analyze visual content, create appropriate time-bounded descriptive narratives, determine suitable insertion points (with context), and adapt the narrative style to match the style of the underlying media.

Embodiments herein can feature a visual context analysis module configured to interpret sequences of video frames, detect periods devoid of audio dialog within said video frames, and generate descriptive metadata reflecting the visual elements and actions depicted within the video content; wherein said analysis utilizes trained machine learning algorithms specific to different genres or sports.

Embodiments herein can feature a narrative generation module coupled to the visual context analysis module, employing a large language model to construct descriptive audio narratives based on the descriptive metadata, with the ability to segment said narratives to fit predetermined non-dialogue windows in the video stream while maintaining continuous context across multiple narrative insertions.

Embodiments herein can feature an audio synthesis module designed to receive the segmented narratives from the narrative generation module and convert text to speech with nuanced control over speech characteristics, including intonation, emotion, prosody, pitch, wherein the synthesized audio is tailored to align with the style of the main performance within the video content and configured so as not to overlap existing dialogue.

Embodiments herein can improve services provided by Streaming Service Providers which can leverage features herein to automate and improve the quality of audio descriptions across their extensive video libraries, increasing accessibility and possibly reducing costs associated with manual audio description production.

Embodiments herein can enhance services provided by Educational Technology platforms which can utilize the system to make educational materials more accessible and engaging for visually impaired learners or those requiring enhanced audio cues to assist with learning, potentially improving education outcomes.

Embodiments herein can enhance services provided by Social Media Platforms which can offer automated audio descriptions for user-generated content, making these platforms more inclusive for users with visual impairments and expanding their user base.

According to one embodiment, a live audio stream can be recorded and delayed by delay period, e.g., 10 seconds. The images leading up to the current live time slot and the next 10 second time slot have been analyzed and identified for the narration of upcoming timeslots where there is no background or other audio. When a timeslot is identified where narration can be added the content, style (intonation, emotion, prosody, pitch) used are based on the large language model and visual data model that have been trained using previous videos from the same genre/sports.

There is set forth herein, e.g., automated generation of audio descriptions for persons without access to video, e.g., visually impaired users, using AI. There is set forth herein, e.g., context-sensitive insertion of audio during silent periods in video content. There is set forth herein, e.g., adaptation of narrative style to match the style of the video. There is set forth herein, e.g., enhancing the viewing experience of produced and delayed-live video streams. There is set forth herein, e.g., enhancing pre-recorded or delayed-live video stream. There is set forth herein, e.g., trained machine learning models for video and language analysis. There is set forth herein, e.g., historical data relevant to the video's genre or sport.

Parameters for narrative timing and style customization can include, in one embodiment, one or more video language model (VLM) such as VLM 4502, one or more large language model (LLM) such as LLM 4508, a cached or recorded video stream, an AI audio narrative injection module, an a module to contextually correlate the AI commentary to existing sound, e.g., by matching style of the injected narrative to the style of the main program.

According to one embodiment, the video stream of the produced video is fully recorded, or the live stream is recorded (cached) and delayed with up to delay period, e.g., 10 seconds and therefore the time window where there is no dialogue or audio is known 10 seconds in advance. If the stream is a near live stream then each narrative can be split up in 0 to 10 seconds chunks of time.

The visual context of what is shown on the screen can be processed using one or more visual language model (VLM) containing large data models for respective video streaming genre and sport. System 100 with use of one or VLM 4502 can use the commentary from previous similar scenarios to build new unique commentary.

Referring back to the previous images of FIG. 5A and FIG. 5B, system 100 including VLM 4502 can provide the below information based on the visual language model having been trained with the relevant content: (A) This is a hockey match (e.g., via pattern and action recognition by VLM 4502); (B) The name of the teams and players based on their numbers on their jerseys (via pattern recognition by VLM 4502); (C) Players history and known facts (via lookup from domain area 2129 of data repository 108); (D) Where on the field the images are taken from and what team are attacking versus defending based on the sequence of the images leading up to current point (e.g., via action recognition by VLM 4502).

Manager system 110 can, e.g., predict next narratives for the upcoming windows based on previous situations (e.g., by VLM 4502 and/or LLM 4508), select the voice pitch, intonation, pace and volume and of the narratives to used, and can employ the language and video models the AI produced narrative solve the following challenges.

In regard to timing, a video stream can be recorded or delayed up to a delay period, e.g., 10 seconds. This allows for injecting a narrative with a pause before and after the narrative without interfering with the audio that exist in the stream.

According to one example, a narrative window of 7 second could produce the following “Player [name] is advancing up the field and has just passed the 23-meter line and pass it to player [name] that is almost at the center line”. This narrative is circa 7 seconds and specifies what is happening and it fits into the 10 second window with a pause before and after the narrative.

If the narrative window is smaller, then the narrative can be made shorter to fit, for example, 5 seconds: “Player [name] receives a pass from the 23-meter line”.

In regard to content, the content of the narrative can be based on the content of the current image and images leading up to the current point.

Example: A still image of a hockey player might not provide the relevant situational information on what is happening other than it is a hockey player, however the images leading up the current image provides the context.

The content of what measurements or statistics to use is based on the images, in this example the home team is European identified from the score board, if the home team was USA then the content can be changed to yards instead of meters.

According to one embodiment, narrative intonation, emotion, prosody and volume to suit the situation can be based on the language model from previous scenarios identified based on the images that has led to the current point.

Example: The previous scenario the pitch, tone, pace and volume is neutral as the play is between the 23 meter line the center line. However, if play in in the shooting line the pitch can be higher, tone can be excited, and the volume elevated based on previous commentary from hockey matches.

Embodiments herein can provide, e.g., descriptive metadata extracted from video content. Embodiments herein can provide, e.g., audio narrative tailored to fit silent gaps in the video stream(s). Embodiments herein can provide, e.g., text-to-speech conversion with nuanced vocal characteristic adaptation and amelioration. Embodiments herein can provide, e.g., continuous and contextually appropriate audio descriptions overlaid on the video (when and where required).

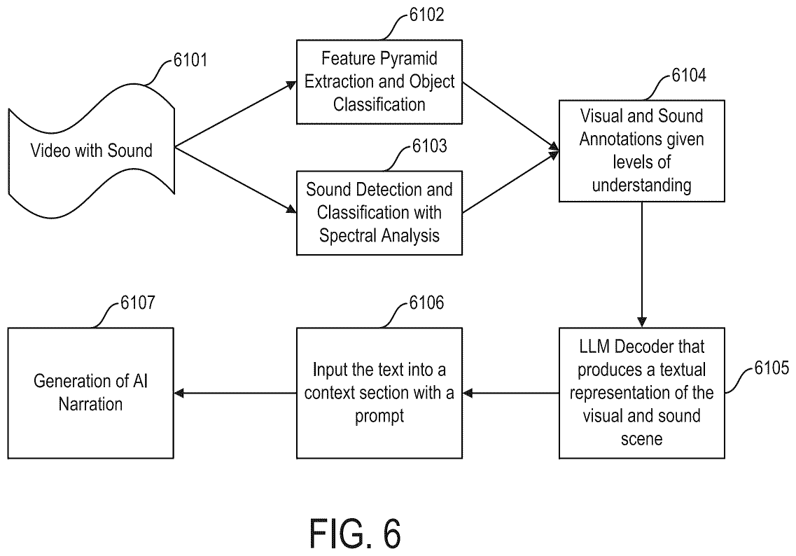

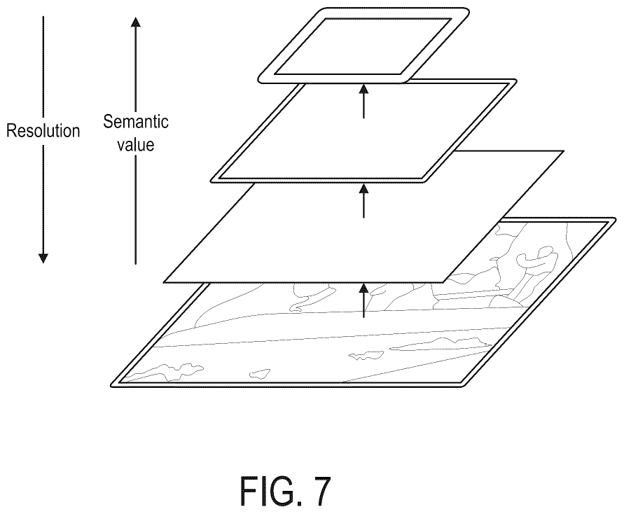

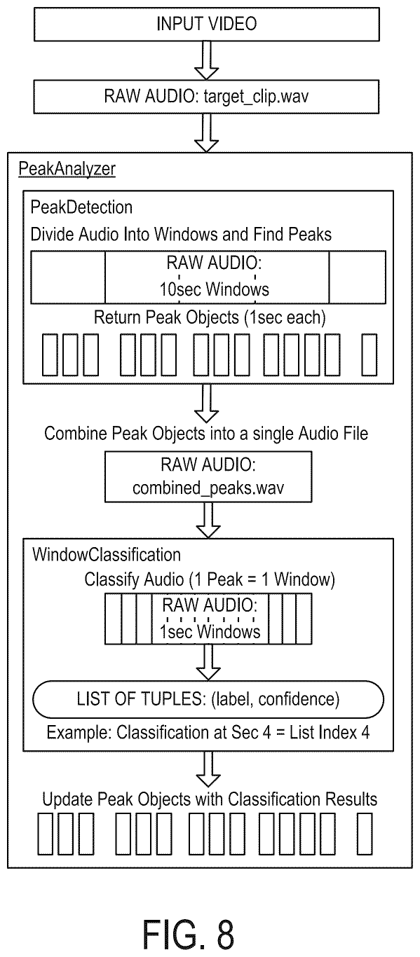

FIG. 6 depicts data flow for the generation of channel-based context pieces for prompts. According to one embodiment, in reference to blocks 6101-6107, video with sound (block 6102) can be streamed into a visual and sound-based context generation module. As set forth in the flow diagram of FIG. 6, a feature pyramid (block 6102) convolutional neural network (CNN) can be applied over the image to detect object for recognition. Each resolution size can be channeled with a particular sound window size. The sound window size on the peaks of a sinusoidal wave can be paired together with the resolution size. Experimentation can generate a polynomial that outputs a sound window size given the features of the scene and the visual resolution size. Several channels of annotations can be created for different resolutions of context generation. A channel interpreter LLM based on decoding or transformer architecture can (block 6105) produce descriptive text. The number of descriptive texts can be equal to the number of channels. Each descriptive text can be part of a context layer that will be input into an overall AI comment prompt. FIG. 7 depicts different resolutions and sampling performed over an image that is input into a convolution neural network (CNN) for classification, and FIG. 8 depicts process flow for different levels of sound windows.

Various available tools, libraries, and/or services can be utilized for implementation of trained predictive models herein trained by machine learning. For example, a machine learning service can provide access to libraries and executable code for support of machine learning functions. A machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. According to one possible implementation, a machine learning service can provide access to a set of REST APIs that can be called from any programming language and that permit the integration of predictive analytics into any application. Enabled REST APIs can provide, e.g., retrieval of metadata for a given predictive model, deployment of models and management of deployed models, online deployment, scoring, batch deployment, stream deployment, monitoring and retraining deployed models. Trained predictive models herein can employ use, e.g., of artificial neural networks (ANNs) support vector machines (SVM), Bayesian networks, and/or other machine learning technologies.

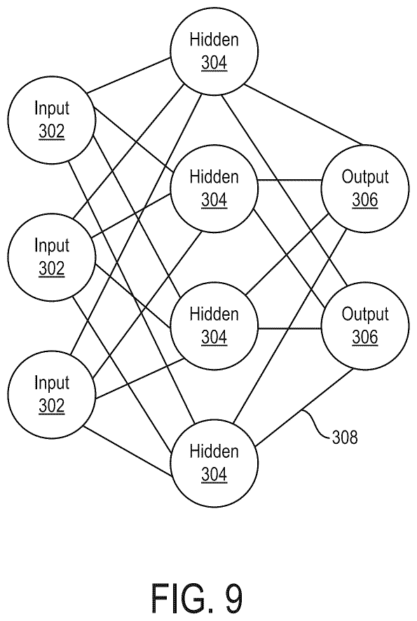

FIG. 9 is an illustration of an example ANN architecture for trained predictive models herein.

One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons.

Referring now to FIG. 9, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 302 that provide information to one or more “hidden” neurons 304. Weighted connections 308 between the input neurons 302 and hidden neurons 304 are weighted, and these weighted inputs are then processed by the hidden neurons 304 according to some function in the hidden neurons 304. There can be any number of layers of hidden neurons 304, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 306 accepts and processes weighted input from the last set of hidden neurons 304.

This represents a “feed-forward” computation, where information propagates from input neurons 302 to the output neurons 306. Upon completion of a feed-forward computation, the output is compared to a desired output available from training data. The error relative to the training data is then processed in “backpropagation” computation, where the hidden neurons 304 and input neurons 302 receive information regarding the error propagating backward from the output neurons 306. Once the backward error propagation has been completed, weight updates are performed, with the weighted connections 308 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output, which can be referred to as outcome training data as referenced in connection with predictive models herein. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process can continue until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, weights of weighted connections 308 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, weights of weighted connections 308 may be implemented as resistive processing units (RPUs), generating a predictable current output when an input voltage is applied in accordance with a settable resistance.

Certain embodiments herein provide improvements to computer technology and other technologies. In one aspect, embodiments herein provide for artificial sight to persons lacking access to viewable content, e.g., unsighted persons, multitasking persons, radio listeners and the like. Embodiments herein generate from video data descriptive text that describes usually observable aspects of the video data when rendered. The descriptive data can be subject to voice synthesis for presentment of synthesized voice and during of descriptive text data. Embodiments herein can time presentment of descriptive text data divining supplementary voice data so as to avoid overlap with a foreground voice data of a media stream. As such, embodiments herein improve the operation of computer systems, particularly in the area of computer systems for presentment of artificial voice data. Embodiments herein can augment an input media stream for production of augmented media stream that includes supplementary voice data. The supplementary voice data can include synthesized voice renderings of descriptive text that describes visually observable attributes of video data defining a scene. Embodiments herein can include detecting open time windows and inserting synthesized voice data into a corresponding open time window of a delayed live stream. Embodiments herein can ploy use of various predictive models including, e.g., VLMs and LLMs which have been tune trained by fine-tuning training to be responsive to prompting data. On the presentment of prompting data defined by video data, a VLM herein can produce candidate text strings describing visually observable attributes of the input video data input as prompting data. Products of the VLM can be input as model prompting data to additional predictive models. Embodiments herein can include various features for accurately predicting duration of open time windows intermediate of foreground voice segments of a media stream. Open time window duration predictions can be based e.g. unprocessed video data and/or processed voice data. According to one example, voice data can be processed to ascertain action and patterns and voice data, and such attributes can be queried can be used as model, prompting data for prompting trained machine learning models which have been trained with historical data that maps video data attributes to observed delay periods between foreground pattern voice segments of historical and current media streams. In another aspect, a semantic meaning of a speaker's voice segment can be applied as model prompting data to a machine learning model that has been trained training data mapping observed foreground voice data delays to semantic meanings associated to foreground pattern voice segments. System ability to artificially render attributes of video data via synthesized speech can be improved by avoiding overlaps between foreground voice segments and supplementary voice segments placed between open time windows.

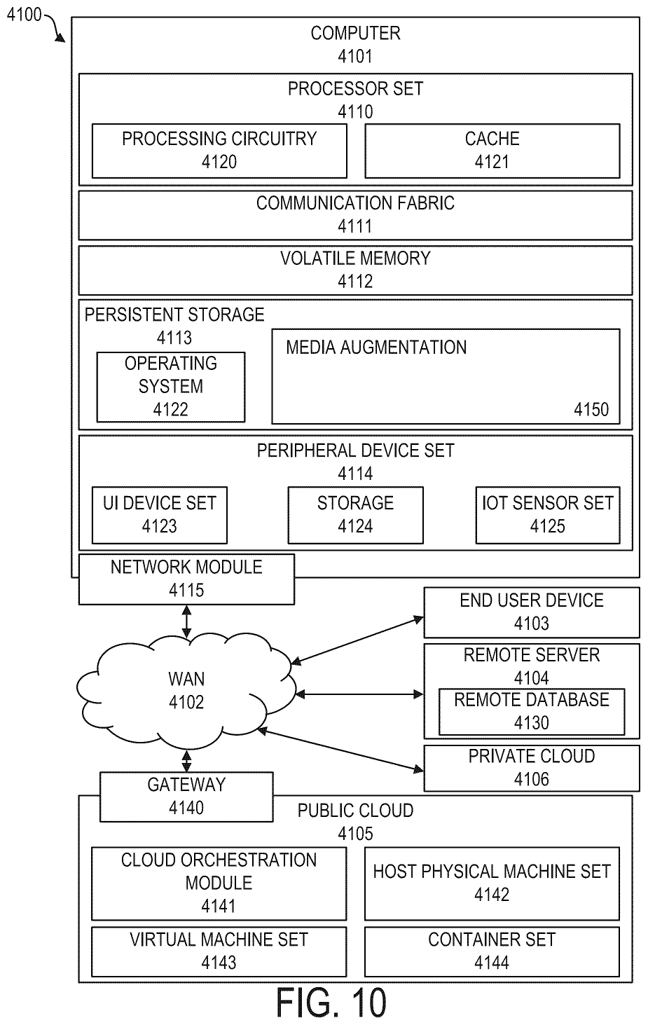

In reference to FIG. 10 there is set forth a description of a computing environment 4100 that can include one or more computer 4101. In one example, a computing node as set forth herein can be provided in accordance with computer 4101 as set forth in FIG. 10.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

One example of a computing environment to perform, incorporate and/or use one or more aspects of the present invention is described with reference to FIG. 13. In one aspect, a computing environment 4100 contains an example of an environment for the execution of at least some of the computer code involved in performing the inventive methods, such as code 4150 for performing media augmentation described with reference to FIGS. 1-9. In addition to block 4150, computing environment 4100 includes, for example, computer 4101, wide area network (WAN) 4102, end user device (EUD) 4103, remote server 4104, public cloud 4105, and private cloud 4106. In this embodiment, computer 4101 includes processor set 4110 (including processing circuitry 4120 and cache 4121), communication fabric 4111, volatile memory 4112, persistent storage 4113 (including operating system 4122 and block 4150, as identified above), peripheral device set 4114 (including user interface (UI) device set 4123, storage 4124, and Internet of Things (IoT) sensor set 4125), and network module 4115. Remote server 4104 includes remote database 4130. Public cloud 4105 includes gateway 4140, cloud orchestration module 4141, host physical machine set 4142, virtual machine set 4143, and container set 4144. IoT sensor set 4125, in one example, can include a Global Positioning Sensor (GPS) device, one or more of a camera, a gyroscope, a temperature sensor, a motion sensor, a humidity sensor, a pulse sensor, a blood pressure (bp) sensor or an audio input device.

Computer 4101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 4130. As is well understood in the art of computer technology, and depending upon the technology, performance of a computer-implemented method may be distributed among multiple computers and/or between multiple locations. On the other hand, in this presentation of computing environment 4100, detailed discussion is focused on a single computer, specifically computer 4101, to keep the presentation as simple as possible. Computer 4101 may be located in a cloud, even though it is not shown in a cloud in FIG. 1. On the other hand, computer 4101 is not required to be in a cloud except to any extent as may be affirmatively indicated.

Processor set 4110 includes one, or more, computer processors of any type now known or to be developed in the future. Processing circuitry 4120 may be distributed over multiple packages, for example, multiple, coordinated integrated circuit chips. Processing circuitry 4120 may implement multiple processor threads and/or multiple processor cores. Cache 4121 is memory that is located in the processor chip package(s) and is typically used for data or code that should be available for rapid access by the threads or cores running on processor set 4110. Cache memories are typically organized into multiple levels depending upon relative proximity to the processing circuitry. Alternatively, some, or all, of the cache for the processor set may be located “off chip.” In some computing environments, processor set 4110 may be designed for working with qubits and performing quantum computing.

Computer readable program instructions are typically loaded onto computer 4101 to cause a series of operational steps to be performed by processor set 4110 of computer 4101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 4121 and the other storage media discussed below. The program instructions, and associated data, are accessed by processor set 4110 to control and direct performance of the inventive methods. In computing environment 4100, at least some of the instructions for performing the inventive methods may be stored in block 4150 in persistent storage 4113.

Communication fabric 4111 is the signal conduction paths that allow the various components of computer 4101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 4112 is any type of volatile memory now known or to be developed in the future. Examples include dynamic type random access memory (RAM) or static type RAM. Typically, the volatile memory is characterized by random access, but this is not required unless affirmatively indicated. In computer 4101, the volatile memory 4112 is located in a single package and is internal to computer 4101, but, alternatively or additionally, the volatile memory may be distributed over multiple packages and/or located externally with respect to computer 4101.

Persistent storage 4113 is any form of non-volatile storage for computers that is now known or to be developed in the future. The non-volatility of this storage means that the stored data is maintained regardless of whether power is being supplied to computer 4101 and/or directly to persistent storage 4113. Persistent storage 4113 may be a read only memory (ROM), but typically at least a portion of the persistent storage allows writing of data, deletion of data and re-writing of data. Some familiar forms of persistent storage include magnetic disks and solid-state storage devices. Operating system 4122 may take several forms, such as various known proprietary operating systems or open source. Portable Operating System Interface-type operating systems that employ a kernel. The code included in block 4150 typically includes at least some of the computer code involved in performing the inventive methods.

Peripheral device set 4114 includes the set of peripheral devices of computer 4101. Data communication connections between the peripheral devices and the other components of computer 4101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 4123 may include components such as a display screen, speaker, microphone, wearable devices (such as goggles and smart watches), keyboard, mouse, printer, touchpad, game controllers, and haptic devices. Storage 4124 is external storage, such as an external hard drive, or insertable storage, such as an SD card. Storage 4124 may be persistent and/or volatile. In some embodiments, storage 4124 may take the form of a quantum computing storage device for storing data in the form of qubits. In embodiments where computer 4101 is required to have a large amount of storage (for example, where computer 4101 locally stores and manages a large database) then this storage may be provided by peripheral storage devices designed for storing very large amounts of data, such as a storage area network (SAN) that is shared by multiple, geographically distributed computers. IoT sensor set 4125 is made up of sensors that can be used in Internet of Things applications. For example, one sensor may be a thermometer and another sensor may be a motion detector. A sensor of IoT sensor set 4125 can alternatively or in addition include, e.g., one or more of a camera, a gyroscope, a humidity sensor, a pulse sensor, a blood pressure (bp) sensor or an audio input device.

Network module 4115 is the collection of computer software, hardware, and firmware that allows computer 4101 to communicate with other computers through WAN 4102. Network module 4115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 4115 are performed on the same physical hardware device. In other embodiments (for example, embodiments that utilize software-defined networking (SDN)), the control functions and the forwarding functions of network module 4115 are performed on physically separate devices, such that the control functions manage several different network hardware devices. Computer readable program instructions for performing the inventive methods can typically be downloaded to computer 4101 from an external computer or external storage device through a network adapter card or network interface included in network module 4115.

WAN 4102 is any wide area network (for example, the internet) capable of communicating computer data over non-local distances by any technology for communicating computer data, now known or to be developed in the future. In some embodiments, the WAN 4102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 4103 is any computer system that is used and controlled by an end user (for example, a customer of an enterprise that operates computer 4101) and may take any of the forms discussed above in connection with computer 4101. EUD 4103 typically receives helpful and useful data from the operations of computer 4101. For example, in a hypothetical case where computer 4101 is designed to provide a recommendation to an end user, this recommendation would typically be communicated from network module 4115 of computer 4101 through WAN 4102 to EUD 4103. In this way, EUD 4103 can display, or otherwise present, the recommendation to an end user. In some embodiments, EUD 4103 may be a client device, such as thin client, heavy client, mainframe computer, desktop computer and so on.

Remote server 4104 is any computer system that serves at least some data and/or functionality to computer 4101. Remote server 4104 may be controlled and used by the same entity that operates computer 4101. Remote server 4104 represents the machine(s) that collect and store helpful and useful data for use by other computers, such as computer 4101. For example, in a hypothetical case where computer 4101 is designed and programmed to provide a recommendation based on historical data, then this historical data may be provided to computer 4101 from remote database 4130 of remote server 4104.

Public cloud 4105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 4105 is performed by the computer hardware and/or software of cloud orchestration module 4141. The computing resources provided by public cloud 4105 are typically implemented by virtual computing environments that run on various computers making up the computers of host physical machine set 4142, which is the universe of physical computers in and/or available to public cloud 4105. The virtual computing environments (VCEs) typically take the form of virtual machines from virtual machine set 4143 and/or containers from container set 4144. It is understood that these VCEs may be stored as images and may be transferred among and between the various physical machine hosts, either as images or after instantiation of the VCE. Cloud orchestration module 4141 manages the transfer and storage of images, deploys new instantiations of VCEs and manages active instantiations of VCE deployments. Gateway 4140 is the collection of computer software, hardware, and firmware that allows public cloud 4105 to communicate through WAN 4102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 4106 is similar to public cloud 4105, except that the computing resources are only available for use by a single enterprise. While private cloud 4106 is depicted as being in communication with WAN 4102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 4105 and private cloud 4106 are both part of a larger hybrid cloud.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Forms of the term “based on” herein encompass relationships where an element is partially based on as well as relationships where an element is entirely based on. Methods, products and systems described as having a certain number of elements can be practiced with less than or greater than the certain number of elements. Furthermore, a device or structure that is configured in a certain way is configured in at least that way but may also be configured in ways that are not listed.

It is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

The corresponding structures, materials, acts, and equivalents of all means or step plus function elements in the claims below, if any, are intended to include any structure, material, or act for performing the function in combination with other claimed elements as specifically claimed. The description set forth herein has been presented for purposes of illustration and description but is not intended to be exhaustive or limited to the form disclosed. Many modifications and variations will be apparent to those of ordinary skill in the art without departing from the scope and spirit of the disclosure. The embodiment was chosen and described in order to best explain the principles of one or more aspects set forth herein and the practical application, and to enable others of ordinary skill in the art to understand one or more aspects as described herein for various embodiments with various modifications as are suited to the particular use contemplated.

What is claimed is:

1. A computer implemented method comprising:
examining foreground voice data of a multimedia stream that includes a video stream data and an audio stream;
identifying in dependence on the examining an open time window that is absent of foreground voice data;
processing, in dependence on the identifying, media stream data of multimedia stream;
generating, in dependence on the processing, a text string for deployment in the open time window, wherein the text string describes content of the video stream;
converting the text string into a synthesized voice segment; and
adapting the audio stream data so that the synthesized voice segment is included in the audio stream and time bounded within the open time window.

2. The computer implemented method of claim 1, wherein the adapting includes modifying a delayed instance of the multimedia stream.

3. The computer implemented method of claim 1, wherein the processing media stream data of the multimedia stream includes processing video data timestamped within the open time window.

4. The computer implemented method of claim 1, wherein the processing media stream data of the multimedia stream includes processing foreground voice data timestamped about the open time window.

5. The computer implemented method of claim 1, wherein the processing media stream data of the multimedia stream includes processing media stream data to predict a time duration of the open time window, and wherein the generating is performed in dependence on the predicted time duration.

6. The computer implemented method of claim 1, wherein the processing media stream data of the multimedia stream includes processing media stream data to predict a style of the open time window, and wherein the generating is performed in dependence on the predicted style.

7. The computer implemented method of claim 1, wherein the processing media stream data of the multimedia stream includes processing media stream data to predict a semantic meaning of foreground voice segment data associated to the open time window, and wherein the generating is performed in dependence on the predicted semantic meaning.

8. The computer implemented method of claim 1, wherein the generating, in dependence on the processing, the text string for deployment in the open time window includes performing evaluating of text string data of the text string according to time window fitment factor, wherein the performing evaluating includes determining a degree to which a predicted time for voice synthesized rendering of the text string data matches a predicted duration of the open time window.

9. The computer implemented method of claim 1, wherein the generating, in dependence on the processing, the text string for deployment in the open time window includes performing evaluating of text string data of the text string according to a style matching factor, wherein the performing evaluating includes determining a degree to which an extracted sentiment of the text string data extracted by subjecting the text string data to natural language processing matches an extracted sentiment of the open time window, wherein extracting sentiment of the open time window includes processing video data of the open time window.

10. The computer implemented method of claim 1, wherein the generating, in dependence on the processing, the text string for deployment in the open time window includes evaluating text string data of the text string according to a semantic meaning redundancy factor, and qualify the text string data for deployment responsively to a determination that a sematic meaning of the text string data is not redundant to a semantic meaning of foreground voice data associated to the open time window.

11. The computer implemented method of claim 1, wherein the generating, in dependence on the processing, the text string for deployment in the open time window includes performing evaluating of text string data of the text string according to an audio-only broadcast emulation factor, wherein the performing evaluating includes determining a degree to which a semantic meaning of the text string data emulates an audio-only broadcast.

12. The computer implemented method of claim 1, wherein the method includes identifying an announcer associated to the foreground voice data, pulling supplemental domain data of the announcer responsively to the identifying, prompting a neural network machine learning model using the supplemental domain data, predicting a duration of the open time window based on an output of the predictive model from the prompting, selecting the text string in dependence on the predicted duration, recording data specifying an actual duration of the open time window, further training the neural network machine learning model using the recorded data specifying the actual duration of the open time window, discovering a subsequent open time window during streaming of the multimedia stream, re-prompting the neural network machine learning model responsively to the discovering, and predicting a duration of the subsequent open time window in dependence on the further training.

13. The computer implemented method of claim 1, wherein the processing media stream data of the multimedia stream includes recognizing based on processing video data of open time window, a certain attribute indicative of an alert game event of a sports game, prompting a sentiment predicting machine learning model with use of the certain attribute, wherein the sentiment predicting machine learning model has been trained with labeled training data associating certain sentiment to the certain attribute, outputting a predicted sentiment based on the prompting, and configuring acoustical characteristics of the synthesized voice segment in dependence on the predicted sentiment.

14. The computer implemented method of claim 1, wherein the method includes selecting text string data for deployment, identifying a break point of the text string data that divides the text string data into the text string and a second text string, storing the second text string to a data repository, and deploying the second text string to a next open time window.

15. The computer implemented method of claim 1, wherein the processing media stream data of the multimedia stream includes processing media stream data to predict (i) a time duration of the open time window, (ii) a sentiment of the open time window, and (iii) a semantic meaning of foreground voice segment data associated to the open time window, wherein the generating, in dependence on the processing, the text string for deployment in the open time window includes selecting the text string to (a) match the time duration of the open time window, (b) match the sentiment of the open time window, and (c) avoid redundancy with the semantic meaning of foreground voice segment data associated to the open time window.

16. The computer implemented method of claim 1, wherein the processing media stream data of the multimedia stream includes processing media stream data to predict (i) a time duration of the open time window, (ii) a sentiment of the open time window, and (iii) a semantic meaning of foreground voice segment data associated to the open time window, wherein the generating, in dependence on the processing, the text string for deployment in the open time window includes selecting the text string to (a) match the time duration of the open time window, (b) match the sentiment of the open time window, and (c) avoid redundancy with the semantic meaning of foreground voice segment data associated to the open time window, wherein the generating, in dependence on the processing, the text string for deployment in the open time window includes (1) obtaining one or more video data frame timestamped about a time of the open time window, and (2) applying the one or more video data frame timestamped about a time of the open time window as model prompting data to a visual language model (VLM) that has been trained with iterations of training data, wherein the iterations of training data include historical frame data labeled with descriptive text, (3) obtaining output text output from the VLM responsively to the applying, (4) prompting a large language model (LLM) using the output text output from the VLM, (5) evaluating VLM-output text strings output by the LLM responsively to the prompting as candidate text strings for deployment in the open time window, wherein the VLM-output text strings include the text string, and (6) selecting the text string from the candidate text strings based on the evaluating, wherein the evaluating includes a time window fitment evaluation factor, a style matching factor, and a factor that includes evaluation of a semantic meaning of the candidate text strings.

17. The computer implemented method of claim 1, wherein the generating, in dependence on the processing, the text string for deployment in the open time window includes (a) obtaining one or more video data frame timestamped about a time of the open time window, and (b) applying the one or more video data frame timestamped about a time of the open time window as model prompting data to a machine learning model that has been trained with iterations of training data, wherein the iterations of training data include historical frame data labeled with descriptive text.

18. The computer implemented method of claim 1, wherein the generating, in dependence on the processing, the text string for deployment in the open time window includes (a) obtaining one or more video data frame timestamped about a time of the open time window, and (b) applying the one or more video data frame timestamped about a time of the open time window as model prompting data to a visual language model (VLM) that has been trained with iterations of training data, wherein the iterations of training data include historical frame data labeled with descriptive text, (c) obtaining output text output from the VLM responsively to the applying, (d) prompting a large language model (LLM) using the output text output from the VLM, (e) evaluating VLM-output text strings output by the LLM responsively to the prompting as candidate text strings for deployment in the open time window, wherein the VLM-output text strings include the text string, and (f) selecting the text string from the candidate text strings based on the evaluating, wherein the evaluating include time window fitment evaluation factor, a style matching factor, and a factor that includes evaluation of a semantic meaning of the candidate text strings.

19. A system comprising:
a memory;
at least one processor in communication with the memory; and
program instructions executable by one or more processor via the memory to perform a method comprising:
examining foreground voice data of a multimedia stream that includes a video stream data and an audio stream;
identifying in dependence on the examining an open time window that is absent of foreground voice data;
processing, in dependence on the identifying, media stream data of multimedia stream;
generating, in dependence on the processing, a text string for deployment in the open time window, wherein the text string describes content of the video stream;
converting the text string into a synthesized voice segment; and
adapting the audio stream data so that the synthesized voice segment is included in the audio stream and time bounded within the open time window.

20. A computer program product comprising:
a computer readable storage medium readable by one or more processing circuit and storing instructions for execution by one or more processor for performing a method comprising:
examining foreground voice data of a multimedia stream that includes a video stream data and an audio stream;
identifying in dependence on the examining an open time window that is absent of foreground voice data;
processing, in dependence on the identifying, media stream data of multimedia stream;
generating, in dependence on the processing, a text string for deployment in the open time window, wherein the text string describes content of the video stream;
converting the text string into a synthesized voice segment; and
adapting the audio stream data so that the synthesized voice segment is included in the audio stream and time bounded within the open time window.
